(19) United States
(12) Patent Application Publication
(10) Pub. No.: US 2025/0363624 A1
(43) Pub. Date: Nov. 27, 2025

(54) ANALYZING SCANNED GOLF BALLS

(71) Applicant: SMGB TECHNOLOGIES LLC, Melbourne, FL (US)

(72) Inventors: Timothy W. Chase, Melbourne, FL (US); Graham Chattan Dodge, Westminster, MD (US); Ishaan Javali, Murphy, TX (US)

(21) Appl. No.: 19/297,347

(22) Filed: Aug. 12, 2025

Related U.S. Application Data
(63) Continuation of application No. PCT/US2024/014556, filed on Feb. 6, 2024.
(60) Provisional application No. 63/446,554, filed on Feb. 17, 2023.

(51) Int. Cl. G06T 7/00; G06V 10/764

(52) U.S. Cl. CPC G06T 7/001; G06V 10/764; G06T 2207/30224

(57) ABSTRACT

The present teachings include computer program products, systems, methods, and platforms for scanning a golf ball (or similar) by a user (e.g., using a smartphone while on a golf course, driving range, practice area, pro shop, or similar) to identify and assess attributes and features thereof, such as manufacturer/brand, model, condition, playability, and so on. The present teachings may also or instead provide advantages and/or disadvantages related to playing with a certain type and/or condition of golf ball or the like, and make recommendations for golf balls for a user, where such information may be customized to the particular user—e.g., via a user inputting, or the system otherwise retrieving, information related to play and/or preferences of the user, such as the user's handicap or skill level, playing style, desired distance and/or trajectory, age, weight, gender, physical fitness level and/or strength, handedness, value preference, expected durability, and so on.

### CROSS-REFERENCE TO RELATED APPLICATIONS

This application is a bypass continuation that claims priority to International Patent App. No. PCT/US2024/014556 filed on Feb. 6, 2024, which claims priority to U.S. Provisional Pat. App. No. 63/446,554 filed on Feb. 17, 2023, where the entire contents of each of the foregoing applications are hereby incorporated by reference herein.

### FIELD

The present disclosure generally relates to computer-implemented techniques for analyzing golf balls or similar from a scan of the ball to identify and assess salient information, e.g., identifying the ball such as by brand and/or model, assessing its compatibility with a player, and/or determining a condition of the ball.

### BACKGROUND

There remains a need for techniques for scanning a golf ball or similar to uncover attributes and features thereof, and/or to assess a golf ball or similar in view of one or more players.

### SUMMARY

The present teachings include computer program products, systems, methods, and platforms for scanning a golf ball (or similar) by a user (e.g., using a smartphone while on a golf course, driving range, practice area, pro shop, or similar) to identify and assess attributes and features thereof, such as manufacturer/brand, model, condition, playability, and so on. The present teachings may also or instead provide advantages and/or disadvantages related to playing with a certain type and/or condition of golf ball or the like, and make recommendations for golf balls for a user, where such information may be customized to the particular user—e.g., via a user inputting, or the system otherwise retrieving, information related to play and/or preferences of the user, such as the user's handicap or skill level, playing style, desired distance and/or trajectory, age, weight, gender, physical fitness level and/or strength, handedness, value preference, expected durability, and so on.

In an aspect, a computer program product disclosed herein may include computer executable code embodied in a non-transitory computer readable medium that, when executing on one or more computing devices, performs the steps of: receiving a scan of a golf ball from a user device, the scan performed using a camera of the user device; analyzing the scan using one or more identification algorithms to identify the golf ball, the one or more identification algorithms performing at least one of character recognition and logo recognition to determine at least one of a brand and a model of the golf ball; querying a golf ball database for one or more play-based attributes of the identified golf ball, the golf ball database including a plurality of play-based attributes for each of a plurality of golf balls; receiving user data from a user, the user data including information related to at least one of playing characteristics, playing preferences, and challenges during play for the user; comparing, using one or more matching algorithms, the user data to the one or more play-based attributes of the identified golf ball; scoring, using the one or more matching algorithms, a compatibility of the identified golf ball for the user based on the comparison of the user data to the one or more play-based attributes; presenting, on a display of the user device, a score for the compatibility of the identified golf ball for the user; analyzing the scan, using one or more damage analysis models trained on a plurality of images of golf balls of varying conditions, to identify a condition of the golf ball; scoring, using the one or more damage analysis models, a playability of the golf ball based on the condition and the user data; and presenting, on the display of the user device, a metric related to the playability of the golf ball for the user. Other embodiments of this aspect include corresponding computer systems, apparatus, and computer programs recorded on one or more computer storage devices, each configured to perform the actions of the methods disclosed herein. Other embodiments of this aspect also or instead include a method performing one of more of the aforementioned steps. Other embodiments of this aspect also or instead include a system having a data network, a plurality of processors coupled to the data network, and a remote computing resource coupled to the data network, the remote computing resource including a processor and a memory, the memory storing code executable by the processor to perform one of more of the aforementioned steps. Other embodiments of this aspect also or instead include a system having a user device including a camera and a display, one or more models stored in a memory, the one or more models configured to analyze a scan of a golf ball performed using the camera of the user device, and a processor configured by computer executable code to perform one of more of the aforementioned steps.

Implementations may include one or more of the following features. The computer program product may include code that, when executing on one or more computing devices, causes the one or more computing devices to perform the steps of: comparing, using the one or more matching algorithms, the user data to the plurality of play-based attributes of golf balls in the golf ball database that are different from the identified golf ball; selecting, using the one or more matching algorithms, one or more candidate golf balls for the user based on the comparison of the user data to the plurality of play-based attributes; and presenting at least one of the one or more candidate golf balls to the user. The one or more matching algorithms may weigh one or more of the plurality of play-based attributes based on the user data when selecting the one or more candidate golf balls for the user. The computer program product may include code that, when executing on one or more computing devices, causes the one or more computing devices to perform the steps of: scoring the one or more candidate golf balls for the user based on the comparison of the user data to the plurality of play-based attributes; and ranking the one or more candidate golf balls based on the scoring. The computer program product may include code that, when executing on one or more computing devices, causes the one or more computing devices to perform the step of presenting the top three candidate golf balls to the user according to the scoring. The one or more matching algorithms may weigh one or more of the play-based attributes of the identified golf ball based on the user data when scoring the compatibility of the identified golf ball. An identification algorithm of the one or more identification algorithms may be programmatically configured to extract text from the golf ball, and to perform fuzzy matching based on the extracted text and a database of text included on certain golf balls. The fuzzy matching may account for one or more variations and errors in the extracted text. An identification algorithm of the one or more identification algorithms may be programmatically configured to extract at least a portion of a logo from the golf ball, and to perform fuzzy matching based on the extracted logo and a database of logos included on certain golf balls. The fuzzy matching may account for one or more variations and errors in the extracted logo. An identification algorithm of the one or more identification algorithms may be programmatically configured to extract one or more features included on a surface of the golf ball, and to perform fuzzy matching based on the one or more features and a database of features included on certain golf balls. The one or more features on the surface of the golf ball may include an attribute related to one or more dimples included on the surface of the golf ball. The one or more features on the surface of the golf ball may include a color of the golf ball. The one or more features on the surface of the golf ball may include markings on the golf ball. An identification algorithm of the one or more identification algorithms may be trained using a dataset of a plurality of images of golf balls, the dataset including one or more tags for each of the plurality of images, the one or more tags including at least one of a brand, a model, and a logo. The one or more tags may further include at least one of a lighting condition and an orientation. The one or more damage analysis models may analyze one or more dimples included on the golf ball. The one or more damage analysis models may analyze one or more color changes on the golf ball. The one or more damage analysis models may analyze a geometry of at least a portion of a surface of the golf ball. The condition of the golf ball may account for a presence of one or more of a scuff, a scratch, and soiling on a surface of the golf ball. The condition of the golf ball may account for a defect in an overall shape of the golf ball. The metric related to the playability of the golf ball may include at least one of: a recommendation not to play with the golf ball, an indication that the golf ball may cause impaired play, an indication that the golf ball is in a playable condition, and an indication that the golf ball is in a new condition. The metric related to the playability of the golf ball may include a grade related to playability. The user data may be received from a questionnaire presented to the user on the user device. The user data may include one or more of the following: gender, age, drive distance, ball flight, desired ball trajectory, challenges faced, greenside spin, handicap, score range, value preference, and an expected durability of golf balls. The user data may be weighted. Weighting of the user data may be based at least in part on an identification of importance of certain information provided by the user. The user data may influence the metric related to the playability of the golf ball for the user. The user data may include data from a population of users, and, the data from the population of users may be used, at least in part, to score the compatibility of the golf ball, to make a recommendation of candidate golf balls, or to score the playability of the golf ball. The user device may include a smartphone. The computer program product may include code that, when executing on one or more computing devices, causes the one or more computing devices to perform the step of displaying an image of the identified golf ball on the display of the user device. The computer program product may include code that, when executing on one or more computing devices, causes the one or more computing devices to perform the step of identifying one or more third-party logos on the golf ball based on the scan. Implementations of the described techniques may include hardware, a method or process, computer software on a computer-accessible medium, and a system.

In an aspect, a computer program product disclosed herein may include computer executable code embodied in a non-transitory computer readable medium that, when executing on one or more computing devices, performs the steps of: receiving a scan of a golf ball from a user device, the scan performed using a camera of the user device; analyzing the scan using one or more identification algorithms to identify the golf ball, the one or more identification algorithms performing at least one of character recognition and logo recognition to determine at least one of a brand and a model of the golf ball; querying a golf ball database for one or more play-based attributes of the identified golf ball, the golf ball database including a plurality of play-based attributes for each of a plurality of golf balls; receiving user data from a user, the user data including information related to at least one of playing characteristics, playing preferences, and challenges during play for the user; comparing, using one or more matching algorithms, the user data to the one or more play-based attributes of the identified golf ball; scoring, using the one or more matching algorithms, a compatibility of the identified golf ball for the user based on the comparison of the user data to the one or more play-based attributes; and presenting, on a display of the user device, a score for the compatibility of the identified golf ball for the user. Other embodiments of this aspect include corresponding computer systems, apparatus, and computer programs recorded on one or more computer storage devices, each configured to perform the actions of the methods disclosed herein. Other embodiments of this aspect also or instead include a method performing one of more of the aforementioned steps. Other embodiments of this aspect also or instead include a system having a data network, a plurality of processors coupled to the data network, and a remote computing resource coupled to the data network, the remote computing resource including a processor and a memory, the memory storing code executable by the processor to perform one of more of the aforementioned steps. Other embodiments of this aspect also or instead include a system having a user device including a camera and a display, one or more models stored in a memory, the one or more models configured to analyze a scan of a golf ball performed using the camera of the user device, and a processor configured by computer executable code to perform one of more of the aforementioned steps.

Implementations may include one or more of the following features. The computer program product may include code that, when executing on one or more computing devices, causes the one or more computing devices to perform the steps of: comparing, using the one or more matching algorithms, the user data to the plurality of play-based attributes of golf balls in the golf ball database that are different from the identified golf ball; selecting, using the one or more matching algorithms, one or more candidate golf balls for the user based on the comparison of the user data to the plurality of play-based attributes; and presenting at least one of the one or more candidate golf balls to the user. Implementations of the described techniques may include hardware, a method or process, computer software on a computer-accessible medium, and a system.

In an aspect, a computer program product disclosed herein may include computer executable code embodied in a non-transitory computer readable medium that, when executing on one or more computing devices, performs the steps of: receiving a scan of a golf ball from a user device, the scan performed using a camera of the user device; analyzing the scan, using one or more damage analysis models trained on a plurality of images of golf balls of varying conditions, to identify a condition of the golf ball; receiving user data from a user, the user data including information related to at least one of playing characteristics, playing preferences, and challenges during play for the user; scoring, using the one or more damage analysis models, a playability of the golf ball based on the condition and the user data; and presenting, on a display of the user device, a metric related to the playability of the golf ball for the user. Other embodiments of this aspect include corresponding computer systems, apparatus, and computer programs recorded on one or more computer storage devices, each configured to perform the actions of the methods disclosed herein. Other embodiments of this aspect also or instead include a method performing one of more of the aforementioned steps. Other embodiments of this aspect also or instead include a system having a data network, a plurality of processors coupled to the data network, and a remote computing resource coupled to the data network, the remote computing resource including a processor and a memory, the memory storing code executable by the processor to perform one of more of the aforementioned steps. Other embodiments of this aspect also or instead include a system having a user device including a camera and a display, one or more models stored in a memory, the one or more models configured to analyze a scan of a golf ball performed using the camera of the user device, and a processor configured by computer executable code to perform one of more of the aforementioned steps.

These and other features, aspects, and advantages of the present teachings will become better understood with reference to the following description, examples, and appended claims.

### BRIEF DESCRIPTION OF THE DRAWINGS

The foregoing and other objects, features and advantages of the devices, systems, and methods described herein will be apparent from the following description of particular embodiments thereof, as illustrated in the accompanying drawings. The drawings are not necessarily to scale, emphasis instead being placed upon illustrating the principles of the devices, systems, and methods described herein. In the drawings, like reference numerals generally identify corresponding elements.

FIG. 1 illustrates a system for golf ball assessment, in accordance with a representative embodiment.

FIG. 2 is a flow diagram illustrating a technique for analyzing scanned golf balls for salient information, in accordance with a representative embodiment.

FIG. 3 is a flow chart of a method for analyzing scanned golf balls for salient information based at least in part on image analysis of a golf ball, in accordance with a representative embodiment.

FIG. 4 is a flow chart of a method for analyzing scanned golf balls for salient information based at least in part on image analysis of a golf ball, in accordance with a representative embodiment.

FIG. 5 is a flow diagram showing use of a platform for scanning an object such as a golf ball, in accordance with a representative embodiment.

FIG. 6 shows an example of object recognition, in accordance with a representative embodiment.

FIG. 7 shows screenshots of a platform for scanning an object such as a golf ball, in accordance with a representative embodiment.

FIG. 8 shows screenshots of a platform for scanning an object such as a golf ball, in accordance with a representative embodiment.

FIG. 9 shows screenshots of a platform for scanning an object such as a golf ball, in accordance with a representative embodiment.

FIG. 10 shows screenshots of a platform for scanning an object such as a golf ball, in accordance with a representative embodiment.

FIG. 11 shows screenshots of a platform for scanning an object such as a golf ball, in accordance with a representative embodiment.

### DETAILED DESCRIPTION

The embodiments will now be described more fully hereinafter with reference to the accompanying figures, in which preferred embodiments are shown. The foregoing may, however, be embodied in many different forms and should not be construed as limited to the illustrated embodiments set forth herein. Rather, these illustrated embodiments are provided so that this disclosure will convey the scope to those skilled in the art.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately” or the like, when accompanying a numerical value, are to be construed as indicating a deviation as would be appreciated by one of ordinary skill in the art to operate satisfactorily for an intended purpose. Similarly, words of approximation such as “about,” “approximately,” or “substantially” when used in reference to physical characteristics, should be understood to contemplate a range of deviations that would be appreciated by one of ordinary skill in the art to operate satisfactorily for a corresponding use, function, purpose, or the like. Ranges of values and/or numeric values are provided herein as examples only, and do not constitute a limitation on the scope of the described embodiments. Where ranges of values are provided, they are also intended to include each value within the range as if set forth individually, unless expressly stated to the contrary. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it is understood that terms such as “first,” “second,” “top,” “bottom,” “up,” “down,” and the like, are words of convenience and are not to be construed as limiting terms unless specifically stated to the contrary.

The present teachings generally relate to techniques for scanning a golf ball or similar to identify the ball, uncover attributes and features thereof, assess its condition, and so on, where any of the foregoing information may be assessed in view of attributes of a particular user to provide custom feedback and/or recommendations for the particular user. For example, the present disclosure includes computer program products, systems, methods, and platforms for scanning a golf ball (or similar) by a user, e.g., using a mobile computing device such as a smartphone while on a golf course, driving range, practice area, pro shop or other store, at home, or similar. Computer-implemented techniques (e.g., a processor executing one or more algorithms, mathematical models, machine learning models, and so on) may then be used to analyze the scan to identify the golf ball, assess its features (e.g., in view of user information to relate these features to a user's game and/or preferences, such as by scoring or otherwise rating the golf ball, and/or by providing advantages/disadvantages), assess its condition (e.g., in view of user information to relate the assessed condition to a user's game and/or preferences, such as by scoring or otherwise rating the golf ball, and/or by providing advantages/disadvantages), and/or provide recommendations for other golf balls for the user. By way of example, a golfer may use the present teachings to scan a golf ball to assess whether the scanned ball: is damaged (e.g., dented, scratched, scuffed, and so on), could benefit from cleaning, to learn whether the ball suits the golfer's game and/or physical attributes, and the like. Thus, aspects of the present teachings may be used to do one or more of the following: determine which golf balls fit a user's game, filter out golf balls that a user should not be playing with, save/store the golf balls that work best for a user (e.g., in a database on a computing platform accessible to the user), review the condition and/or playability of golf balls, and so on.

It will be understood that although this disclosure may refer to “golf balls,” the present teachings can be adapted for use in scanning other objects, such as other sports balls or similar. Thus, any reference to a “golf ball” or “ball” herein is intended to include other objects and items, unless expressly stated to the contrary or otherwise clear from the context.

In general, the present teachings may include a system or platform where scanning a golf ball or the like will produce salient information for a user, e.g., on a user interface of a computing device such as a mobile phone or similar. For example, one or more scans (and/or images) of a golf ball may be processed (e.g., using image-based processing techniques, and/or three-dimensional model processing, including the use of machine learning models or similar)—either on a user device and/or on a remote server or the like—to identify (e.g., via machine learning models trained on voluminous images of similar objects having various attributes and features) attributes and features thereof, such as manufacturer, brand, model, damage, condition, cleanliness, advantages, disadvantages, third-party information, and so on. It will be understood that “scanning” (or similar) as described herein may include a three-dimensional scan and/or one or more images captured via a camera of a computing device (e.g., a smartphone) for processing output of such a “scan” for uncovering attributes of the scanned item(s).

In aspects, the present teachings may include using a smartphone camera or other optical digital device coupled to a computer processor, where the present teachings use one or more of object detection, optical character recognition, machine learning computer vision techniques, and the like, to correctly identify a golf ball, its manufacturer and model, and/or to determine whether any damage exists on the surface of the ball. The present teachings may use Tensor Flow libraries (or similar) deployed in a mobile application using Tensor Flow Lite (or similar).

Thus some advantages of the present teachings—which, again, may include scanning a golf ball with a smartphone or the like, where backend algorithms analyze the scan to uncover and provide information related thereto—may include removing the need for guesswork, troubleshooting/experimentation, and/or tedious searching on behalf of the user. Further, in some aspects, if a user answers a few brief questions or prompts about their playing style and/or preferences, the present teachings can provide personalized recommendations related to golf balls.

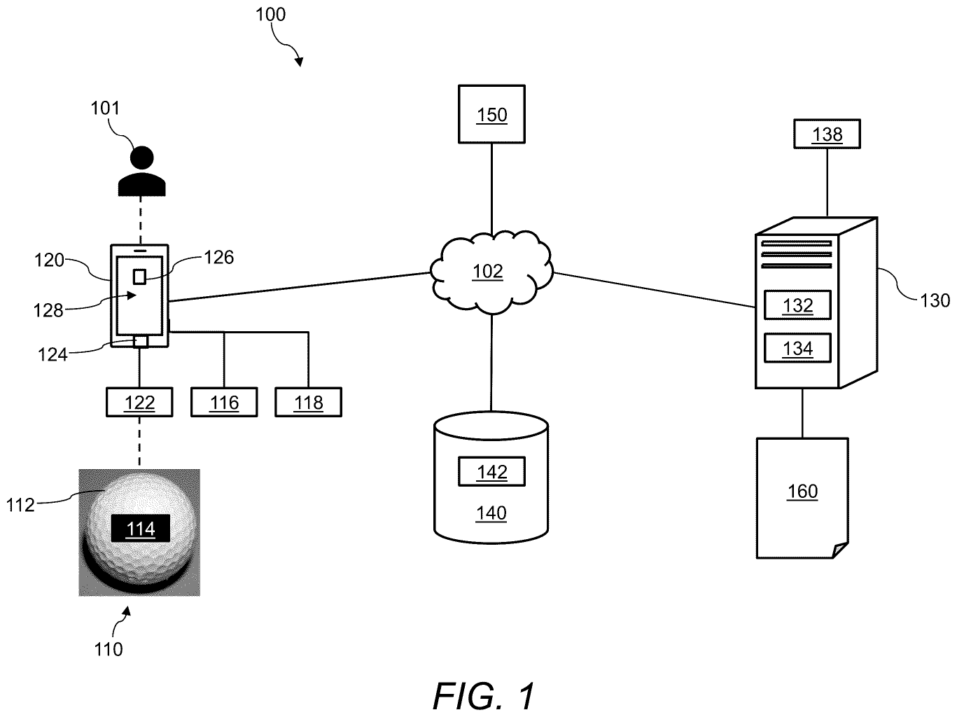

FIG. 1 illustrates a system for golf ball assessment, in accordance with a representative embodiment. More particularly, the system 100 may be used for scanning a golf ball 110, and analyzing the scan 122 of the golf ball 110 to provide salient information to a user 101, where such information may be customized for the user 101. In general, the system 100 may include a networked environment where a data network 102 interconnects a plurality of participating devices and/or users 101 in a communicating relationship. The participating devices may, for example, include any number of user devices 120, remote computing resources 130, databases 140, and other resources 150. Generally, the system 100 may be used for any of the implementations of the present teachings described herein. For example, the system 100 may be used for analyzing a scan 122 of a golf ball 110 to identify the golf ball 110, provide an assessment thereof, and/or to make recommendations and/or provide other output 160 to a user 101. More specifically, in the system 100, a user 101 may capture or otherwise retrieve a scan 122 of a golf ball 110 (e.g., a golf ball 110 associated with the user 101 and/or a golf ball 110 under consideration by a user 101), transmit that scan 122 or information related thereto over the data network 102 to a remote computing resource 130 for processing and analysis (which may occur automatically), where the remote computing resource 130 then provides output 160 of the analysis to the user 101 over the data network 102. Also or instead, in the system 100, a user 101 may capture or otherwise retrieve a scan 122 of a golf ball 110 for local processing and analysis using the user device 120, where local processing capability of the user device 120 provides the output 160 of the analysis to the user 101. This entire process can be done relatively quickly, e.g., in near real-time (such as less than five minutes, less than one minute, mere seconds or shorter, etc.). Certain participants and aspects of the system 100 will now be described.

The user 101 may be associated with the user device 120—e.g., such as where the user device 120 is a smartphone, tablet, or similar. The user 101 may also or instead be associated with the golf ball 110. For example, the user 101 may be a golfer that owns the golf ball 110, is considering purchasing and/or using the golf ball 110, or similar. The user 101 may also or instead include an individual otherwise interested in learning about the golf ball 110—e.g., a shop owner, a golf professional (e.g., a trainer, a caddy, a course professional, a golf club/course employee or owner, a driving range employee or owner, and the like), a golf simulator user or professional associated therewith, someone considering balls for another person, and so on. In some instances, the user 101 may not be human, but instead the user 101 may include a computing device, computer program, or the like—e.g., where the user 101 is a computer-program product comprising computer executable code embodied in a non-transitory computer readable medium that, when executing on one or more computing devices (e.g., the user device 120) is configured to capture, create, edit, receive, and/or transmit a scan 122 for processing and analysis as described herein for obtaining output 160 or the like.

The data network 102 may be any network(s) or internetwork(s) suitable for communicating data and information among participants in the system 100. This may include public networks such as the Internet, private networks, telecommunications networks such as the Public Switched Telephone Network or cellular networks using third generation (e.g., 3G or IMT-2000), fourth generation (e.g., LTE (E-UTRA) or WiMAX-Advanced (IEEE 802.16m)), fifth generation (e.g., 5G), and/or other technologies, as well as any of a variety of corporate area or local area networks and other switches, routers, hubs, gateways, and the like that might be used to carry data among participants in the system 100.

Each of the participants of the data network 102 may include a suitable network interface comprising, e.g., a network interface card, which term is used broadly herein to include any hardware (along with software, firmware, or the like to control operation of same) suitable for establishing and maintaining wired and/or wireless communications. The network interface card may include without limitation a wired Ethernet network interface card (“NIC”), a wireless 802.11 networking card, a wireless 802.11 USB device, or other hardware for wired or wireless local area networking. The network interface may also or instead include cellular network hardware, wide-area wireless network hardware or any other hardware for centralized, ad hoc, peer-to-peer, or other radio communications that might be used to connect to a network and carry data. In another aspect, the network interface may include a serial or USB port to directly connect to a local computing device such as a desktop computer that, in turn, provides more general network connectivity to the data network 102.

The golf ball 110 may be any as described herein—e.g., a ball that a user 101 currently owns (used or new), a ball under consideration for use or purchase by the user 101, a found ball, and so on. As noted above, the golf ball 110 may not necessarily be a “golf” ball, but instead may include another sports ball, piece of athletic equipment, or other object capable of being scanned and analyzed according to the present teachings. Thus, as discussed above, it will be understood that, although the present teachings may emphasize the use and analysis of a scan 122 of a golf ball 110, the system 100 may also or instead include analysis of other object's scans or images.

The golf ball 110 may include an overall shape/geometry (e.g., substantially spherical) with a surface 112 having one or more features 114 thereon. Such features 114 may include, by way of example, one or more of the following: dimples (e.g., presence, absence, condition, quantity, depth, shape, size, and/or other characteristics thereof), color, color changes, markings (e.g., text, a logo, a brand, a model, a serial number or other demarcation, a third-party marking, a marketing attribute, alignment features, and the like), condition attributes (e.g., a scrape, scratch, dent, scuff, hole, chip, other surface defect, dirt, debris, other foreign object(s), and so on), texture, and the like. A feature 114 of the golf ball 110 may also or instead include a wholistic characteristic, such as overall size and/or overall shape.

The user devices 120 may include any devices within the system 100 operated by one or more users 101 for practicing the techniques as contemplated herein. The user devices 120 may thus be coupled to the data network 102. Specifically, the user devices 120 may include any device for capturing a scan 122 (e.g., a camera lens, a structured light scanner, a laser scanner, a time-of-flight (ToF) camera, a photogrammetry system, a handheld scanner, and the like)—or otherwise creating, preparing, editing, or receiving the scan 122—and, in some instances, transmitting the scan 122 for analysis (e.g., over the data network 102). To this end, the user device 120 may include a camera 124 or the like, or the user device 120 may otherwise be in communication with a camera 124 or the like. In a preferred implementation, the user device 120 includes a smartphone or the like having an internal camera 124, processing capability, and access to the data network 102, all in a one device. The user device 120 may also or instead include any device for receiving output 160 of an analysis of the scan 122 over the data network 102, e.g., displaying such output 160 on a display 128 featuring a graphical user interface 126 or the like. Similarly, the user device 120 may include any device for creating, preparing, editing, receiving, and/or transmitting (e.g., over the data network 102) other data or files in the system 100, such as metadata 116 (e.g., metadata 116 related to one or more of the user 101, the user device 120, or the scan 122), user data 118, and so on. The user device 120 may also or instead include any device for managing, monitoring, or otherwise interacting with tools, platforms, and devices included in the systems and techniques contemplated herein. The user device 120 may be coupled to the data network 102, e.g., for interaction with one or more other participants in the system 100. It will also be understood that all or part of the functionality of the system 100 described herein may be performed on the user device 120 (or another component of the system 100) without a connection to the data network 102—by way of example, a closed network native application on a smartphone may be utilized, whereby functionality (e.g., one or more of the models 138 described herein) can run in a closed environment.

By way of further example, the user devices 120 may include one or more desktop computers, laptop computers, network computers, tablets, mobile devices, portable digital assistants, messaging devices, cellular phones, smartphones, portable media or entertainment devices, rangefinders, GPS devices, swing analyzers, golf simulator equipment, or any other computing devices that can participate in the system 100 as contemplated herein. As discussed above, the user devices 120 may include any form of mobile device, such as any wireless, battery-powered device, that might be used to interact with the networked system 100. It will also be appreciated that one of the user devices 120 may coordinate related functions (e.g., performing processing and/or analysis of the scan 122 and the like) as they are performed by another entity such as one of the remote computing resources 130 or other resources 150.

Each user device 120 may generally provide a user interface 126. The user interface 126 may be maintained by a locally-executing application on one of the user devices 120 that receives data from, for example, the remote computing resources 130 or other resources 150. In other embodiments, the user interface 126 may be remotely served and presented on one of the user devices 120, such as where a remote computing resource 130 or other resource 150 includes a web server that provides information through one or more web pages or the like that can be displayed within a web browser or similar client executing on one of the user devices 120. The user interface 126 may in general create a suitable visual presentation for user interaction on a display device of one of the user devices 120, and provide for receiving any suitable form of user input including, e.g., input from a keyboard, mouse, touchpad, touch screen, hand gesture, or other use input device(s).

The remote computing resources 130 may include, or otherwise be in communication with, a processor 132 and a memory 134, where the memory 134 stores code executable by the processor 132 to perform various techniques of the present teachings. More specifically, a remote computing resource 130 may be coupled to the data network 102 and accessible to the user device 120 through the data network 102, where the remote computing resource 130 includes a processor 132 and a memory 134, where the memory 134 stores code executable by the processor 132 to perform the steps of a method according to the present teachings-such as any of the methods or techniques described herein. However, it will be understood that such a processor 132 and a memory 134 may also or instead be located on the user device 120.

The remote computing resources 130 may also or instead include data storage, a network interface, and/or other processing circuitry. In the following description, where the functions or configuration of a remote computing resource 130 are described, this is intended to include corresponding functions or configuration (e.g., by programming) of a processor 132 of the remote computing resource 130, or in communication with the remote computing resource 130. In general, the remote computing resources 130 (or one or more processors 132 thereof or in communication therewith) may perform a variety of processing tasks related to analyzing a scan 122 of a golf ball 110, and further assessment and processing related thereto, as discussed herein. For example, the remote computing resources 130 may manage information received from one or more of the user devices 120 (e.g., the scan 122, metadata 116, user data 118, and so on), and provide related supporting functions such as parsing or segmentation of the scan 122 for analysis, normalization of the scan 122, performing calculations, identifying and extracting various properties and attributes of the scan 122, calculating features of the contents of the scan 122, applying one or more models 138 and/or algorithms to the scan 122, metadata 116, and/or user data 118, retrieving and/or analyzing information from a database 140 and/or the memory 134, providing an output 160, communicating with other resources 150 and the participants in the system 100, storing data, and the like. The remote computing resources 130 may also or instead include backend algorithms that react to actions performed by a user 101 at one or more of the user devices 120. These backend algorithms may also or instead be located elsewhere in the system 100.

The remote computing resources 130 may also or instead include a web server or similar front end that facilitates web-based access by the user devices 120 to the capabilities of the remote computing resource 130 or other components of the system 100. A remote computing resource 130 may also or instead communicate with other resources 150 in order to obtain information for providing to a user 101 through a user interface 126 on the user device 120. Where the user 101 specifies certain criteria for analysis or otherwise, this information may be used by a remote computing resource 130 (and any associated models 138) to access other resources 150. Additional processing may be usefully performed in this context such as recommending certain analyses, as well as processing operations and techniques.

A remote computing resource 130 may also or instead maintain, or otherwise be in communication with, a database 140 of data 142, and optionally with an interface for users 101 at the user devices 120 to utilize the data 142 of such a database 140. Thus, in one aspect, a remote computing resource 130 may include a database 140 of data 142, and the remote computing resource 130 may act as a server that provides a platform for selecting and using such data 142, and/or providing supporting services related thereto. The database 140 may be a local database of the remote computing resource 130, or a remote database to the remote computing resource 130 or another participant in the system 100. Thus, the database 140 may include a cloud-based database or the like.

The data 142 included in the database 140 or otherwise in the system 100 may include one or more of metadata 116 and user data 118. Examples of metadata 116 that may be stored in the database 140 or otherwise for use in the system 100, which may be related to the scan 122 or otherwise, may include one or more of: descriptive metadata, administrative metadata, technical metadata, structural metadata, rights metadata, geospatial metadata, relational metadata, usage metadata, version metadata, and so forth. By way of example, metadata 116 may include a location of the user 101 and/or golf ball 110, a time and date of the scan 122, application usage information, other information pertaining to the user 101, and so on.

As set forth in more detail below, user data 118 may be obtained from the user 101 or otherwise, e.g., retrieved from a database 140 or third party. For example, the user data 118 may, at least in part, be formed from a user 101 or third party answering questions on a questionnaire presented to the user 101 on the user interface 126 of the user device 120. The user data 118 may be used at least in part to provide certain output 160 to the user 101, and may thus be used in the processing and analyses described herein—e.g., to customize recommendations made to the user 101. In this manner, the user data 118 may include information related to at least one of playing characteristics, playing preferences, and challenges during play for the user 101. By way of further example, the user data 118 may include one or more of the following: gender, age, drive distance, ball flight, desired ball trajectory, challenges faced when playing, greenside spin, handicap, score range, value preference, an expected durability of golf balls, and the like. The user data 118 may also or instead include user input regarding an importance of certain information contained within the user data 118 for the user 101, where this importance may be used in weighting of the user data 118 in analyses described herein. It will be understood that user data 118 may be used for analyses related to one or more of: identifying a golf ball 110, determining a compatibility of a golf ball 110 for the user 101, making recommendations to the user 101 (such as recommendations of one or more golf balls 110 for their game and/or preferences), and/or a determining a playability of the golf ball 110.

In some aspects, a database 140 of the system 100 includes user data 118 for a population of users 101. Such user data 118 for a population of users 101 may be used, at least in part, in one or more of the analyses described herein. For example, if user data 118 specific to a first user is incomplete, user data 118 from the population of users 101 may be used to fill the gap—e.g., where user data 118 from one or more similarly situated users is used, and/or where an average, mean, median, or the like is used, which can be taken from an entire population or a subset thereof. In this manner, user data 118 in the present teachings may include a wealth of useful data related to playing characteristics, playing preferences, challenges during play, and otherwise for one or more users 101.

The data 142 stored in a database 140 of the system 100 may also or instead include reference information for use by the remote computing resource 130 for providing the output 160. For example, this data 142 may include historical data such as information from analyses of one or more golf balls 110 (e.g., from the same user 101 or a different user). The data 142 may also or instead include one or more models 138, e.g., for retrieval and use by the remote computing resource 130 or another participant for processing and analyzing the scan 122 or other information to generate the output 160. The data 142 may also or instead include a plurality of scans 122 or images (e.g., of the same or different golf ball 110, from the same user 101 or a different user, and so on). The data 142 may also or instead include a number of correlations and/or associations between one or more pieces of information.

To this end, in some aspects, the database 140 may be a golf ball database including data 142 such as a plurality of play-based attributes for each of a plurality of golf balls 110. By way of example, such play-based attributes may include information related to at least one of the following for each of a plurality of golf balls: compression (e.g., whether a ball has relatively low compression, medium compression, or high compression, where typically lower compression balls are suitable for players with slower swing speeds, providing more distance and a softer feel, and where typically higher compression balls are firmer and better suited for players with higher swing speeds, as they may help maintain control and reduce spin); cover type and/or material (e.g., surlyn resin or a similar ionomer resin, which can provide durability, have a harder feel, and is often used in lower-cost balls; or urethane, which can offer better spin control and a softer feel, and is often used in premium golf balls); dimple pattern, which may include the number of dimples (dimple count) and/or the dimple design (e.g., where the number of dimples can affect aerodynamics and trajectory, and where different dimple patterns can be engineered to reduce drag, enhance lift, and/or optimize ball flight); layer construction and/or count, such as two-piece, which can provide maximum distance and durability, three-piece, which can offer a balance of distance and control, or multi-layer, which is typical four or five-piece construction, and which can incorporate more layers for added spin control and feel, and is often preferred by advanced players; core material, such as a soft core (e.g., contributing to a softer feel and/or providing more spin on approach shots) or a hard core (e.g., offering a firmer feel, contributing to lower spin rates, and/or providing more distance); spin rate (e.g., greenstopping spin) such as low spin (e.g., providing more distance off the tec but potentially limiting control on approach shots), mid spin (e.g., balancing distance and control, suitable for a wide range of players), and high spin (e.g., aiding in control on approach shots and around the greens); feel (e.g., a soft feel or a firm feel); alignment aids and/or related gameplay markings; other markings or appearance characteristics; size; shape; and the like. The data 142 may also or instead include other information related to golf balls such as one or more of: value and/or cost (e.g., where balls can be labeled as bargain, moderate, premium, or the like); whether the ball conforms to certain standards (e.g., whether the ball is legal according to certain leagues and/or organizations); year of manufacture or information related to age (e.g., whether a model and/or brand is still produced); whether a ball is suited for certain weather and/or other environmental conditions; whether the ball is designed for a certain gender, age, or other demographics; whether the ball is designed for certain skill levels; and the like. Such data 142 may be created, added, removed, and/or revised in any of a number of ways, including automatically by data scraping from information provided by manufacturers or the like (e.g., web scraping to extract information from websites using automated tools or scripts to gather data from web pages), and/or manually by administrators, and so on.

A remote computing resource 130 may also or instead be configured to manage access to certain content (e.g., for a particular user 101). In one aspect, a remote computing resource 130 may manage access to a component of the system 100 by a user device 120 according to input from a user 101.

Thus, and as described throughout the present disclosure, a remote computing resource 130 coupled to the data network 102 and accessible to the user device 120 through the data network 102 may include a processor 132 and a memory 134, where the memory 134 stores code executable by the processor 132 to perform the steps of any of the methods described herein. Also or instead, the user device 120 itself may include a processor 132 and a memory 134, where the memory 134 stores code executable by the processor 132 to perform the steps of any of the methods described herein. By way of example, such a method may include one or more of the following: identifying a golf ball 110, determining a compatibility of a golf ball 110 for the user 101, making recommendations to the user 101 (such as recommendations of one or more golf balls 110 for their game and/or preferences), and/or a determining a playability of the golf ball 110. More specifically, in an aspect, a system 100 disclosed herein may include: a user device 120 including a camera 124 and a display 128, one or more models 138 stored in a memory 134, the one or more models 138 configured to analyze a scan 122 of a golf ball 110 performed using the camera 124 of the user device 120, and a processor 132 configured by computer executable code to perform the steps of: analyzing the scan 122 using the one or more models 138 to identify the golf ball 110, the one or more models 138 performing at least one of character recognition and logo recognition to determine at least one of a brand and a model of the golf ball 110; querying a database 140 (e.g., a golf ball database) for data 142 related to one or more play-based attributes of the identified golf ball 110, the database 140 including a plurality of play-based attributes for each of a plurality of golf balls; receiving user data 118 from a user 101, the user data 118 including information related to at least one of playing characteristics, playing preferences, and challenges during play for the user 101; comparing, using the one or more models 138, the user data 118 to the one or more play-based attributes of the identified golf ball 110; scoring, using the one or more models 138, a compatibility of the identified golf ball 110 for the user 101 based on the comparison of the user data 118 to the one or more play-based attributes; presenting, on the display 128 of the user device 120, a score or other similar output 160 related to the compatibility of the identified golf ball 110 for the user 101; analyzing the scan 122, using a model of the one or more models 138 trained on a plurality of images of golf balls of varying conditions, to identify a condition of the golf ball 110; scoring, using the one or more models 138, a playability of the golf ball 110 based on the condition and the user data 118; and presenting, on the display 128 of the user device 120, a metric or other similar output 160 related to the playability of the golf ball 110 for the user 101. In some aspects, the processor 132 executes, at least in part, on the user device 120. In some aspects, the processor 132 executes, at least in part, on a remote computing resource 130 (e.g., a remote server) coupled to the user device 120 through the data network 102.

As discussed herein, the systems 100 and techniques of the present teachings may include and utilize one or more models 138 that are configured and programmed to perform certain tasks to assist with the various analyses described herein. By way of example, parsing the scan 122 that is received or retrieved for analysis may involve segmenting the scan 122, which can be performed at least in part by a specific segmentation model, e.g., a deep learning model. This segmentation model may read-in the scan 122 and label specific classes in the scan 122 (e.g., a class for the golf ball 110 and a class for background), where the segmentation model can be rewarded for correctly identifying certain pixels and punished when the segmentation model is incorrect when identifying certain pixels. The segmentation model may thus be configured to extract the background from the scan 122 for analysis of only the golf ball 110 contained therein. The segmentation model may also or instead normalize one or more attributes of the content within the scan 122, normalize one or more color planes of the content within the scan 122, account for lighting or other conditions, and so on. By way of example, a segmentation model may define a region of interest within a scan 122, which may be a region of wholly or partially containing dimples or other features 114 of the golf ball 110, for extraction/analysis of a visual feature thereof (e.g., after a normalization is performed).

A model 138 can also or instead include a geometric model—e.g., a model 138 specifically configured and programmed to identify and determine (e.g., calculate) geometric features of content within the scan 122—e.g., geometric features including but not limited to morphological region properties, which can include one or more of contiguous pixel areas, a perimeter, major/minor axes, and the like. Such a geometric model may include machine-learning models such as random forest. These models can optionally be trained with optimized hyper parameters using a grid search routine, which may have advantageous accuracy. Such a geometric model may also or instead include other machine learning models, including without limitation, one or more of k-nearest neighbor, support vector machine, logistic regression, decision trees (which can be gradient-boosted and/or combined in ensemble architectures), Naïve Bayes, Multi-Layer Perceptron, or the like.

A model 138 can also or instead include a color model—e.g., a model 138 specifically configured and programmed to identify and determine color of contents within the scan 122, or other color-related attributes and/or features. Such a color model may include a multilinear model, e.g., with lasso correction or the like. The output of color model may include a color index, which can be in the form of a color wheel, a list of colors within a portion of the scan 122, a sum of the top color planes, and the like.

A model 138 may also or instead include a convolutional neural network. Such a model 138 may be a ResNet-18 convolutional neural network, ResNet-34, and/or the like. Other networks such as VGG could also or instead be employed. Also, or instead, k-mean image segmentation may be utilized in the present teachings, where a pseudo-color plane is created (e.g., specifically for the present teachings), which can allow the present teachings to identify and determine the top ‘n’ most abundant colors in an image. This can also or instead permit the present teachings to identify and determine color homogeneity within an image.

Supervised machine learning may find an association between data (e.g., feature vectors X) and a corresponding label (y, which can be categorical or continuous) so that the computer can learn an algorithm, f, that maps the input to the output (e.g., y=f (X)). Two further subgroups can include classification and regression problems, where the supervised machine-learning model is trained to predict categorical data and continuous data, respectively. Some examples of models include: support vector machines, stochastic gradient descent, k nearest neighbors, decision trees, neural networks, and so on.

Unsupervised machine learning may assume a similar structure to supervised machine learning, except that no training labels y may be used. These models may attempt to learn the underlying structure or distribution of the data to learn more about its behavior. Some example of tasks here are clustering and associations (e.g., Apriori algorithms for association rule learning). Semi-supervised approaches may occur when practitioners feed in a partial list of labeled training data. This typically increases accuracy as a result of using labeled data, but allows for practitioners to minimize cost (e.g., time and monetary to gather labeled data).

Transfer learning may include a technique that leverages open-source models that have been trained on significantly more images. For example, Inception was trained on 1.4M images, and is a well-known network for classification tasks. The model and/or model weights can be adapted for a custom task by appending a custom deep neural network after an appropriate layer in Inception to tune the model weights towards a custom classification task according to the present teachings.

In general, the models 138 may include one or more of a computer vision model (e.g., where such a computer vision model uses semantic segmentation to detect a region of interest within the scan 122), a U-Net segmentation model, a machine-learning model, a transfer learning model (e.g., where weights are adapted from a network trained in an existing model, such as a VGG-16 model), a correlation model, a deep learning model, and so on.

In some aspects, one or more of the models 138 may be trained using one or more scans 122 from a population of users, which can be classified and/or tagged for such purposes. It will be understood that, in some aspects, the scans 122 include one or more images, where such images may be used to train one or more of the models 138.

The other resources 150 may include any resources that can be usefully employed in the devices, systems, and methods as described herein. For example, these other resources 150 may include without limitation other data networks, human actors (e.g., programmers, researchers, annotators, editors, analysts, and so forth), sensors (e.g., audio or visual sensors), data mining tools, computational tools, data monitoring tools, algorithms, and so forth. The other resources 150 may also or instead include any other software or hardware resources that may be usefully employed in the networked applications as contemplated herein. For example, the other resources 150 may include payment processing servers or platforms used to authorize payment for access, content, or option/feature purchases, or otherwise. In another aspect, the other resources 150 may include certificate servers or other security resources for third-party verification of identity, encryption or decryption of data, and so forth. In another aspect, the other resources 150 may include a desktop computer or the like co-located (e.g., on the same local area network with, or directly coupled to through a serial or USB cable) with one of the user devices 120 or remote computing resources 130. In this case, the other resource 150 may provide supplemental functions for the user device 120 and/or remote computing resource 130. Other resources 150 may also or instead include supplemental resources such as cameras, scanners, input devices, and so forth.

The other resources 150 may also or instead include one or more web servers that provide web-based access to and from any of the other participants in the system 100. While depicted as a separate network entity, it will be readily appreciated that the other resources 150 (e.g., a web server) may also or instead be logically and/or physically associated with one of the other devices described herein, and may, for example, include or provide a user interface for web access to a remote computing resource 130 or a database 140 in a manner that permits user interaction through the data network 102, e.g., from a user device 120.

It will be understood that the participants in the system 100 may include any hardware or software to perform various functions as described herein. For example, one or more of the user device 120 and the other resources 150 may include a memory 134 and a processor 132.

The various components of the networked system 100 described above may be arranged and configured to support the techniques, processes, and methods described herein in a variety of ways. For example, in one aspect, a user device 120 connects through the data network 102 to a server (e.g., that is part of one or more of the remote computing resource 130 or other resources 150) that performs a variety of processing tasks related to analyzing a scan 122 of a golf ball 110 to provide output 160 that is useful to a user 101. For example, the remote computing resource 130 may include a server that hosts a website (and/or a mobile application or application programming interface) that runs a platform for analyzing and/or processing a scan 122 and other data. More specifically, a user 101 associated with the user device 120 and having appropriate permissions for using the system 100 may use the user device 120 to transmit a scan 122, user data 118, and/or metadata 116 over the data network 102 to the remote computing resource 130. The remote computing resource 130 may receive the scan 122 from the user 101 over the data network 102 for processing and analysis thereof, where a result of the processing and analysis may include the output 160.

The output 160 may include one or more of the following: an identification of the scanned golf ball 110; information related to a compatibility of the identified golf ball 110 for the user 101, e.g., based on a comparison of user data 118 to one or more play-based attributes of the identified golf ball 110; a recommendation of one or more golf balls 110 for the user 101; a condition of a scanned golf ball 110; and/or information related to a playability of a scanned golf ball 110, e.g., based on a condition thereof and user data 118. For example, the output 160 may include a score for the compatibility of a golf ball 110 for a user 101. The output 160 may also or instead include a metric related to the playability of a golf ball 110 for a user 101. The output 160 may also or instead include candidate golf balls for a user 101, which may be ranked accordingly to account for user data 118, weighting, and the like. The output 160 may be programmatically configured for presentation on the display 128 (and more specifically, the graphical user interface 126) of the user device 120.

In an aspect, many of the techniques of the present teachings are performed by the remote computing resource 130. For example, the remote computing resource 130 may include an analysis engine (or otherwise a processor 132) configured by computer-executable code to analyze the scan 122 (and/or user data 118, metadata 116, and the like), a recommendation engine (or otherwise a processor 132) configured by computer-executable code to provide a recommendation for the user 101, and so on. However, it will be understood that some of the features and functionality described with reference to the remote computing resource 130 may also or instead be performed by another participant in the system 100.

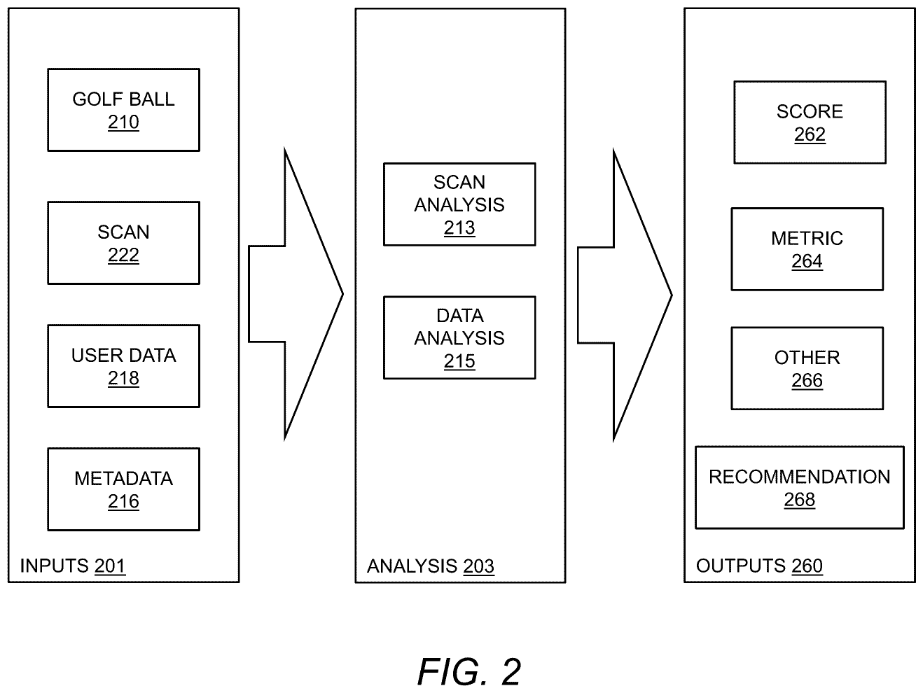

FIG. 2 is a flow diagram illustrating a technique for analyzing scanned golf balls for salient information, in accordance with a representative embodiment. As shown in the figure, inputs 201 may include, but are not limited to, a golf ball 210, a scan 222 of the golf ball 210, user data 218, and metadata 216. By way of example, the user data 218 and/or metadata 216 may be in the form of questionnaire responses, user input, administrative input, sensed data, and/or retrieved data, which may be related to a user's golf game and/or preferences.

The respective inputs 201 may then be analyzed as shown in the analysis 203 portion of the figure. The analysis 203 may include a scan analysis 213 of the supplied scan 222, and/or a data analysis 215 of one or more of the user data 218, the metadata 216, and the like. For one or more of the inputs 201, analyzed data may be compared to a reference database.

The outputs 260 may include, but are not limited to, any as described herein such as a score 262 (e.g., a score for the compatibility of a golf ball for a user), a metric 264 (e.g., a metric related to a playability of a golf ball for a user), other information 266 (e.g., information or data relating to one or more golf balls, images or other graphics, and the like), and a recommendation (e.g., a recommendation regarding a certain ball, such as the ball present in the supplied scan 222, a recommendation related to other golf balls, and so on), and the like.

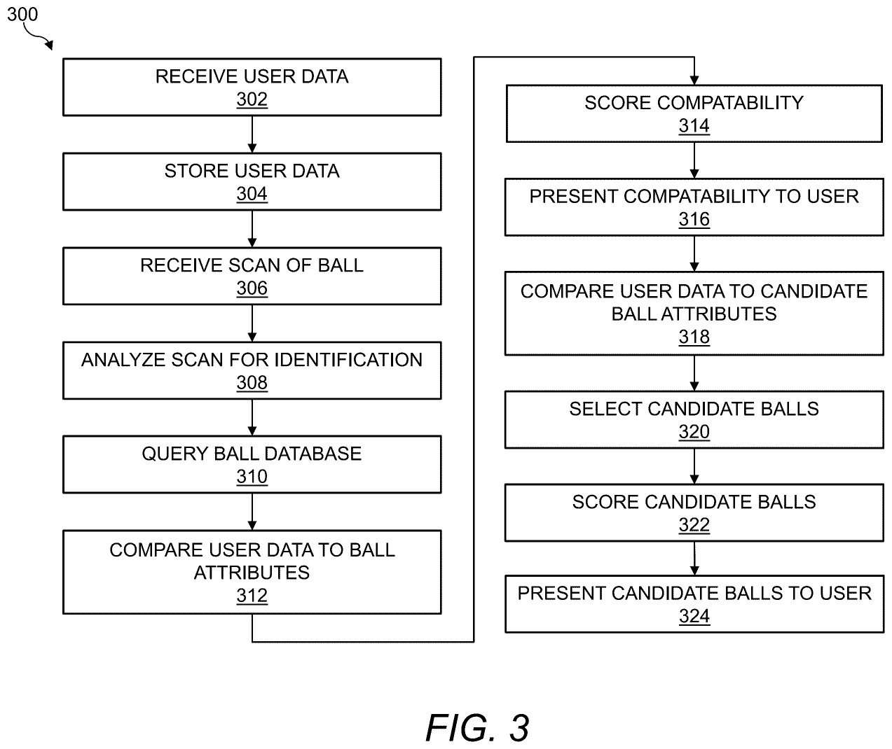

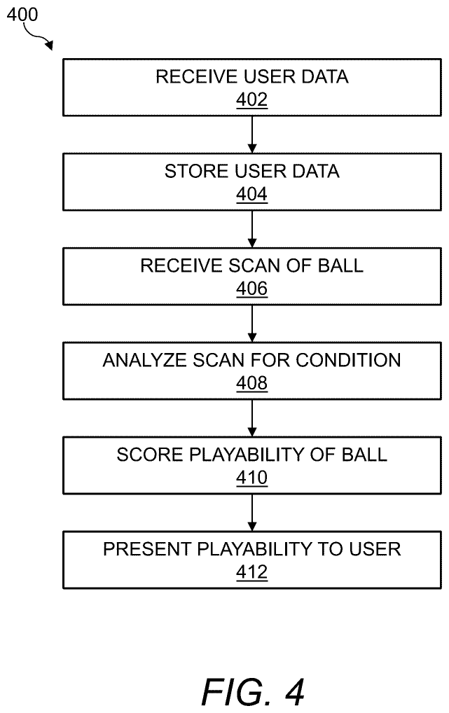

FIG. 3 is a flow chart of a method for analyzing scanned golf balls for salient information based at least in part on image analysis of a golf ball, in accordance with a representative embodiment. As stated throughout this disclosure, although the method 300 may use a “golf ball” as an example, the method 300 may be performed on other scanned balls or other objects. In general, the method 300 may be performed via a mobile application on a user device (e.g., smartphone) and may relate to identifying a golf ball, determining its compatibility with a user, and/or making recommendations of candidate golf balls for the user. Thus, in some aspects, the method 300 may be carried out by a computer program product comprising computer executable code embodied in a non-transitory computer readable medium that, when executing on one or more computing devices, causes the one or more computing devices to perform one or more steps of the method 300 (or other methods disclosed herein, such as the method 400 of FIG. 4).

As shown in step 302, the method 300 may include receiving user data. The user data may be received from a user, e.g., a user that provides the user data via prompts from a mobile application executing on a mobile device associate with the user (e.g., smartphone or the like), such as by answering a questionnaire or the like. Thus, the user data may be received from a questionnaire presented to the user on a user device. The user data may include any as described herein, such as information related to at least one of: playing characteristics, playing preferences, and/or challenges faced during play for the user. By way of example, the user data may include one or more of the following: gender (and/or whether the user prefers golf balls specifically designed for women), age (and/or whether the user prefers golf balls specifically designed for older players or children), drive distance, ball flight, desired ball trajectory, challenges faced during play, greenside spin, handicap (e.g., a user's United States Golf Association (USGA) handicap index, where such input can be deduced from a user answering questions related to their typical scores, such as whether they rarely break 100, mid 90s, upper 80s and low 90s, mid 80s, upper 70s and low 80s, mid 70s or better, etc.), score range, value preference, an expected durability of golf balls, swing speed (e.g., swing speed of a user's driver, where such input can be deduced from a user answering questions such as those related to the distance that they hit the ball, where actual swing speed is unknown), handedness, physical ability, height and/or other physical attributes of the user, and the like. Furthering one of these examples, user data may include user input related to the user's perceived biggest challenge faced while playing golf, such as distance, accuracy, consistent ball flight, staying on greens, and the like. Furthering another one of these examples, user data may include user input related to the user's perceived common ball flight path, which may include a user selecting or otherwise inputting one or more of the following: straight, draw (i.e., modest right to left for a right-handed player), hook (i.e., significant right to left for a right-handed player), fade (i.e., modest left to right for a right-handed player), slice (i.e., significant left to right for a right-handed player), either, and so on. Furthering another one of these examples, user data may include user input related to the user's play with specific clubs—e.g., where a user answers a prompt related to a result when the user hits a pitching wedge onto a green, identifying whether the ball hits and runs out significantly, hits and runs out somewhat, hits and backs up with backspin, or hits and stops, for example. The user data may also or instead include information related to the user's goals. For example, a user may provide information in the user data related to how they would like to hit their drive trajectory-lower height, mid, mid to high, or higher.

The user data may also or instead include information beyond gameplay information, such as a user's buying preferences or the like. For example, a user may provide information within the user data related to their desire to pay for golf balls—e.g., whether they are willing to pay up to fit their game, whether they want a decent ball that does not cost a fortune, whether they prefer bargain balls, whether they prefer a least expensive option, and so on. The user data may also or instead include information regarding longevity and/or condition preferences for golf balls. For example, a user may provide information in response to a prompt querying about whether they prefer their golf balls to last 9 holes, a few rounds, or as long as possible. In some instances, the user data includes metadata, such as any as described herein.

When user data is collected via a questionnaire or the like, assumptions may be made when answers are missing, a user indicates “I don't know” or similar as an answer to specific prompts, and/or the questionnaire is otherwise blank or incomplete. For example, in some aspects, such assumptions may assume information generally associated with new or beginner-level golfers. Also or instead, assumptions may be drawn from other known attributes of the user, e.g., from metadata provided internally or by a third party, from publicly available information, or the like. Also or instead, assumptions may be drawn from answers provided by other users. For example, user data may include information related to a population of users, and this population can be grouped and/or categorized for drawing inferences, e.g., for filling in gaps in user data or otherwise. By way of example, user data from a population of users may be tagged, categorized, filtered, sorted, parsed, or similar by one or more of: skill level, age, demographics, location, preferences, gender, build, and the like. Thus, in an example, if a user has incomplete user data, an assumption may be made based on user data from another user or set of users, where it is determined that these users are similarly situated such that an assumption would be proper. In this manner, user data for a specific user, when incomplete or otherwise, may be crowd sourced from user data provided by a population of users or a subset thereof, whether similarly situated or otherwise.

The user data may be weighted. To this end, in some aspects, weighting of the user data is based at least in part on an identification of importance of certain information provided by the user. For example, in a questionnaire or the like provided to the user in a mobile application or the like implementing the present teachings, a user may be prompted to rank an importance of: aspects of their game, answers to specific questions, or similar. Weighting may also or instead be provided by default in a system, such as where it is assumed that certain aspects of users' game are more important than others, where such an assumption can be provided through a categorization or otherwise filtered based on user data from a population of users, or a subset thereof. In some cases, a dynamic weighting system may be used, such as were certain user data is weighted differently than other user data, and/or the weighting changes over time, triggered by revised/new user data or otherwise. By way of example, a user's biggest challenge or buying preferences may trigger a different weighting pattern than the user's drive distance or swing speed thereby scoring the ball fitting recommendation differently.

As shown in step 304, the method 300 may include storing the user data. That is, the user data described herein may be stored in a database (e.g., a local and/or remote database relative to a computing device implementing one or more steps of the method 300) for use by the platforms, systems, and techniques of the present teachings. Thus, it shall be understood that, in some aspects, receiving the user data may include retrieval of the user data from one or more databases where such data is stored. Stored user data may be raw data and/or transformed data. By way of example, certain user data may be weighted, tagged and/or labeled, normalized, scaled, categorized, otherwise manipulated, and the like. The user data may be sortable, filterable, searchable, editable, indexable, and so on. In some aspects, the user data is stored in a structured data format (e.g., such as in CSV (Comma Separated Values), TSV (Tab Separated Values), or a relational database), preprocessed or otherwise normalized (e.g., to fill in gaps for missing values, to remove outliers or inconsistencies, and so on), feature engineered, data versioned, data indexed, separated or pulled for use in training or the like (e.g., validation or testing), encrypted or otherwise anonymized, and/or the like.

As shown in step 306, the method 300 may include receiving a scan of a golf ball from a user device, e.g., where the scan is performed using a camera of the user device. The user device may be any computing device as described herein, e.g., a smartphone or the like; and the scan may be any as described herein or known in the art. Stated from a perspective of a user, the method 300 may thus include scanning a golf ball with a user device. In some aspects, in addition to one or more of the analyses described herein, data from the scan may be used for display or other output for the user. For example, the method 300 may include displaying an image of the identified golf ball on the display of the user device—where the image may be taken from the scan or otherwise captured with the user device's camera, or where a representation is displayed for the user. In some aspects, where a representation of the scanned golf ball is used for display, the representation is tailored to one or more aspects of the scanned golf ball, such as having the same color, logo, and/or the like.

As shown in step 308, the method 300 may include analyzing the scan using one or more identification algorithms to identify the golf ball that is scanned by the user. One or more of the identification algorithms may perform at least one of character recognition and logo recognition, e.g., to determine at least one of a brand and a model of the golf ball. By way of example, an identification algorithm of the one or more identification algorithms may be programmatically configured to extract text from the golf ball, and to perform fuzzy matching based on the extracted text and a database of text included on certain golf balls. In certain aspects, the fuzzy matching accounts for one or more variations and/or errors in the extracted text. In this manner, the present teachings may be used in circumstances where incomplete text is provided, and/or where the text is otherwise marked, scuffed, scraped, erased, and so on. Also or instead, an identification algorithm of the one or more identification algorithms may be programmatically configured to extract at least a portion of a logo from the golf ball, and to perform fuzzy matching based on the extracted logo and a database of logos included on certain golf balls. In certain aspects, the fuzzy matching accounts for one or more variations and errors in the extracted logo. In this manner, the present teachings may be used in circumstances where an incomplete or otherwise imperfect logo is provided, and/or where the logo is otherwise marked, scuffed, scraped, erased, and so on.

Also or instead, an identification algorithm of the one or more identification algorithms may be programmatically configured to extract one or more features included on a surface of the golf ball, and to perform fuzzy matching based on the one or more features and a database of features included on certain golf balls. In certain aspects, such features on the surface of the golf ball include an attribute related to one or more dimples included on the surface of the golf ball—e.g., shape, size, quantity, depth, presence, absence, and the like. Also or instead, such features on the surface of the golf ball may include a color of the golf ball. This may include the overall color of the golf ball, coloring on a portion of the golf ball, and/or color changes on the golf ball. Also or instead, such features on the surface of the golf ball may include markings on the golf ball—e.g., manufacturing markings, branding or logo markings, user or third-party applied markings, alignment markings/aids, technology symbols (e.g., symbols or icons representing the technology or features incorporated into the golf ball, such as advanced dimple patterns or specific materials used in construction), quality control markings, recycling symbols, warning labels, and so on.

In some instances, one or more third-party logos and/or markings (i.e., markings not identifying the brand and/or model of the golf ball, bit something else) may be identified from analyzing the scan with one or more algorithms as described herein. For example, this may include one or more of a corporate logo, sports team logo, event logo (e.g., golf tournament, fundraiser, marketing event, and the like), marketing information, personalized markings, numbering, commemorative logos, and the like. To this end, the present teachings may be used to strategically track the use of one or more golf balls. By way of example, if a certain marketing campaign is run for a limited time with golf balls having a particular demarcation relating thereto, scanning of such balls may uncover how long these balls are being used by players, where such balls are being used, and/or other similar, salient information.

An identification algorithm of the one or more identification algorithms may be trained using a dataset of a plurality of images of golf balls. The dataset may include one or more tags for each of the plurality of images. For example, such tags may include at least one of a brand, a model, and a logo. Such tags may also or instead include a lighting condition and/or an orientation, which can be useful for training the identification algorithms to analyze scans captured in different environmental and/or lighting conditions.

As shown in step 310, the method 300 may include querying a golf ball database for one or more play-based attributes of the identified golf ball. As such, the golf ball database may include a plurality of play-based attributes for each of a plurality of golf balls. The play-based attributes may be any as described herein, for example one or more of: compression, cover material, dimple pattern, layer construction, core material, spin rate, feel, alignment aids and/or related gameplay markings, other markings or appearance characteristics, size, shape, and the like. One or more of these play-based attributes may be associated with playing characteristics and/or other properties or characteristics for players found in the user data. Such associations may be any as described herein—e.g., that lower compression balls are typically more suitable for players with slower swing speeds—or otherwise known in the art.

As shown in step 312, the method 300 may include comparing, using one or more matching algorithms, the user data to one or more play-based attributes of the identified golf ball. For example, the matching algorithms described herein may use the aforementioned associations (i.e., of the play-based attributes to playing characteristics and/or other properties for players found in the user data) in an analysis for making recommendations to a user, and/or for other output described herein.

As shown in step 314, the method 300 may include scoring—e.g., using one or more matching algorithms-a compatibility of the identified golf ball for the user based on the comparison of the user data to the one or more play-based attributes. To this end, in some aspects, a matching algorithm may weight one or more of the play-based attributes of the identified golf ball based on the user data when scoring the compatibility of the identified golf ball.

As shown in step 316, the method 300 may include presenting, on a display of the user device, a score for the compatibility of the identified golf ball for the user. The score may include one or more of a grade, label, rating, graph, representation, and the like, or any other information related to the compatibility of the identified golf ball for the user. By way of example, the score may include a percentage fit from 0% to 100%, and may include one or more graphical representations (e.g., shading or coloring on a scale to provide a visual representation of the compatibility).

Instead of, or in addition to, identifying a scanned golf ball and/or presenting information to a user about its compatibility for the user's game and/or preferences, the method 300 may make recommendations of golf balls for the user.

As shown in step 318, the method 300 may include comparing, using one or more matching algorithms, the user data to the plurality of play-based attributes of golf balls in the golf ball database that are different from the identified golf ball. This may be done regardless of whether the scanned golf ball that is identified is determined to be acceptable for the user, or only in circumstances where the identified golf ball is a poor fit for the user.

As shown in step 320, the method 300 may include selecting, using one or more matching algorithms, one or more candidate golf balls for the user based on the comparison of the user data to the plurality of play-based attributes. To this end, in some aspects, a matching algorithm may weight one or more of the plurality of play-based attributes based on the user data when selecting one or more candidate golf balls for the user.

As shown in step 322, the method 300 may include scoring—e.g., using one or more matching algorithms-compatibility of one or more candidate golf balls for the user based on the comparison of the user data to the plurality of play-based attributes, and ranking one or more candidate golf balls based on the scoring. To this end, in some aspects, a matching algorithm may weight one or more of the play-based attributes of the candidate golf balls based on the user data when scoring their compatibility. The scoring may be similar to that described elsewhere herein, and may for example include one or more of a grade, label, rating, graph, representation, and the like.

As shown in step 324, the method 300 may include presenting at least one of the one or more candidate golf balls to the user. In some aspects, the method 300 may include presenting the top three candidate golf balls to the user according to the scoring. In some aspects, the scoring is included in a ranking that shows a percentage fit (or other metric related to compatibility) for the user based on their user data and play-based attributes of the candidate golf ball.

A brief overview of an example of the golf ball identification/recognition process will now be described. The process may include the creation of a diverse custom dataset, aiming to improve recognition across different golf ball brands, models, and/or conditions. Techniques including MobileNet integration, transfer learning, and/or text extraction with fuzzy matching may be employed for precise and nuanced recognition. This example details some methodologies and tools that may be used.

Continuing with this example, a custom dataset may be created and stored for use by one or more models. This may include a custom dataset that is curated, and includes a plurality (4,000 or more) diverse images of golf balls, including different brands, models, lighting conditions, and orientations. The dataset may be annotated to provide accurate information about the location and characteristics of golf balls within each image. A data annotation tool, such as FiftyOne (scc https://voxel51.com, an open source toolkit to build computer vision workflows), may be employed for annotating the golf ball image dataset.

Continuing with this example, for golf ball and logo detection, MobileNet (see, e.g., Howard, et al., “MobileNets: Efficient Convolutional Neural Networks for Mobile Vision Applications,” Google Inc. (2017), available at https://arxiv.org/pdf/1704.04861v1.pdf, and incorporated by reference herein in its entirety), a lightweight deep learning model tailored for mobile and edge devices, or similar, may be integrated with a Single Shot Multibox Detector (SSD) (see, e.g., Liu, et al., “SSD: Single Shot MultiBox Detector,” ECCV (2016), available at https://arxiv.org/abs/1512.02325, and incorporated by reference herein in its entirety), or similar, for the purpose of ball detection, logo detection, and/or classification. Transfer learning may be employed, where a pre-trained MobileNet model or similar is fine-tuned on the custom dataset. This process may enable the model to adapt to the unique features of golf balls and logos.

Continuing with this example, for text extraction from golf ball scans and/or images, within the golf ball dataset, various brands and models may feature textual representations. To this end, ML-Kit OCR models or similar may be utilized to extract text from ball images, aiding in the recognition of golf ball brands and models. For example, a fuzzy matching algorithm may be developed to match the extracted text against expected brand and model names. Fuzzy matching can account for variations or errors in text, ensuring precise associations. This step thus may add a layer of intelligence, allowing for nuanced recognition even in cases of partial or misspelled text.

Continuing with this example, to ensure the accuracy and reliability of the golf ball recognition system, one or more of the following methodologies may be employed. Dataset selection: a diverse dataset representing various golf ball brands, models, and/or logos may be curated for evaluation. Ground truth annotation: annotators may manually or automatically label the dataset with accurate bounding boxes around golf balls and logos. Performance metrics: standard metrics such as Precision, Recall, and FI Score may be employed to evaluate the detection accuracy of the MobileNet-SSD model. Text extraction precision and recall: extracted text may be compared with the annotated ground truth to measure precision and recall. End-to-end evaluation: the complete golf ball recognition system, integrating detection, text extraction, and fuzzy matching, may be evaluated on real-world scenarios. Usability assessment: user feedback and usability studies may be conducted to understand the practical effectiveness of the system.

This example of a golf ball recognition system thus demonstrates a holistic approach to image recognition, combining innovative technology with dataset curation and evaluation methodologies. By integrating MobileNet or similar and employing transfer learning or similar, the system may adapt to diverse golf ball characteristics. The inclusion of text extraction with fuzzy matching may enhance recognition precision, allowing for robust performance even in scenarios involving partial or misspelled text. The evaluation methodologies, encompassing dataset selection, ground truth annotation, and end-to-end assessments, also emphasize the commitment to accuracy and reliability. Further usability assessments and user feedback studies may be used to contribute to the system's practical effectiveness in real-world scenarios, ensuring a comprehensive and user-centric solution for golf ball recognition.

A brief overview of an example of the golf ball recommendation process will now be described. The process may assist users in finding the most suitable golf balls based on their specific preferences and playing style. This process may utilize a comprehensive questionnaire, where users provide input on various salient topics such as their playing characteristics, preferences, and challenges faced during play. To this end, the present teachings may include a fitness algorithm to calculate a fitness score for each golf ball, ranking them based on their compatibility with the user's preferences. The top three recommended golf balls may then be presented to the user, offering a personalized and optimal selection.

An example of the golf ball recommendation process may include the generation of a ball fitness score or the like. For example, a fitness algorithm may consider multiple factors gathered from the user (e.g., via a questionnaire or similar) to determine the fitness score for each golf ball. The questionnaire may cover aspects such as drive distance, ball flight, desired trajectory, challenges faced, greenside spin, handicap, score range, value preference, and the expected durability of the ball. Each factor may be weighted according to its importance, and the algorithm may calculate a comprehensive fitness score for each golf ball in the database, or another subset of balls.

Some specific example factors for consideration regarding ball fitness, and which may be included in an analysis to determine a ball fitness scores are listed below. Gender consideration: differentiates between male and female users; allows for the inclusion or exclusion of ladies' balls based on user preference. Drive length preference: evaluates the user's typical drive length; applies compression criteria based on the user's drive length range. Ball flight pattern: considers the user's reported common ball flight pattern (e.g., straight, draw, hook, fade, slice, etc.); applies dimple criteria based on the reported ball flight. Drive trajectory preference: assesses the user's desired drive trajectory height; applies trajectory criteria based on user preference. Challenges with drives: considers the user's identified challenges with drives (e.g., distance, accuracy, consistency, hitting and staying on greens, etc.); assigns weights to each challenge based on user emphasis. Greenside spin for pitching wedge: assesses the user's desired greenside spin when hitting a pitching wedge into a green; applies spin criteria based on user preference. Handicap and scoring: considers the user's handicap or typical score range; assigns weights to the reported handicap range. Ball selection criteria: evaluates user preferences when buying a golf ball (e.g., value, premium, moderate, bargain, etc.); applies value criteria based on user preferences. Ball longevity preference: considers the user's preference for how long a ball should last before discarding; applies cover type criteria based on user preference.

Continuing with this example, each criterion may be assigned a weight based on its importance—where such an importance may be determined at least in part by an administrator (e.g., set as default for one or more users), set by a user, derived from the user data, derived from third-party data, and the like. And scores may be calculated for each criterion based on user responses. Weighted scores may be summed to generate an overall ball fitness score, e.g., if a user selects a preference for low swing speed, a preference for further distance, and/or a buying preference for low cost golf balls, cumulative weighting can be applied to the scoring, thereby impacting the ball recommendations. Continuing with this example, in general, the higher the ball fitness score, the better the match between the user's preferences and the features of a given golf ball. This may thus provide a personalized recommendation based on user preferences.

Therefore, a golf ball recommendation system of the present teachings may enhance the golfing experience by providing tailored recommendations aligned with the user's preferences and playing characteristics. By incorporating advanced algorithms and user-specific data, the system can ensure that the recommended golf balls align with the user's expectations, contributing to improved performance and enjoyment on the golf course. The system's user-friendly approach and precise fitness scoring can make it a valuable tool for golf enthusiasts seeking the perfect ball for their game.

An example of weighting and scoring for golf balls—e.g., to assess a scanned golf ball and/or to recommend a golf ball for a user-will now be described. A golf ball database may include a plurality of balls with different attributes (e.g., play-based attributes) and features for each ball. At a high level, golf balls may be parsed for scoring and/or recommendations based on a type of golf ball—by way of example, if a user provides input that they will play with a ladies' golf ball, then such balls would be included for analysis, and discarded if not. This can save processing demand by reducing the number of golf balls being evaluated. Other user data may be used in a similar manner to reduce the set of golf balls being analyzed—by way of example, only bargain balls may be recommended to a user that provides an input that they prefer the least expensive ball possible.

Continuing with the example, weighting may factor in user data as inputted by the user via a prompt and/or questionnaire. For example, if a user's biggest challenge is distance, compression may be weighted more than one or more other play-based attributes; if a user's biggest challenge is accuracy, driver spin rate may be weighted more than one or more other play-based attributes; if a user's biggest challenge is consistent ball flight, weighting may place a substantially equal emphasis on compression and driver spin rate; if a user's biggest challenge is hitting and staying on greens, greenside spin may be weighted more than one or more other play-based attributes; and if a user's biggest challenge is unknown, weighting may place a substantially equal emphasis on compression and driver spin rate. Other weighting schemes are also or instead possible.

Also or instead, certain user data may produce a predetermined correspondence, with or without weighting, between the certain user data and a play-based attribute. For example, if swing speed is 70 miles per hour (mph) or less, this may correlate to recommending balls with a compression of 50 or under; if swing speed is between 71-80 mph, this may correlate to recommending balls with a compression between 51-60; if swing speed is between 81-90 mph, this may correlate to recommending balls with a compression between 61-80; if swing speed is between 91-100 mph, this may correlate to recommending balls with a compression between 81-90; and if swing speed is over 101 mph, this may correlate to recommending balls with a compression of at least 91 or more. A similar correspondence may be made between length of typical drive and compression.

FIG. 4 is a flow chart of a method for analyzing scanned golf balls for salient information based at least in part on image analysis of a golf ball, in accordance with a representative embodiment. It shall be understood that the method 400 of FIG. 4 may be performed independently of the method 300 described above for FIG. 3. That is, the method 400 of FIG. 4 generally describes embodiments where a golf ball is scanned by a user, machine learning algorithms analyze the scan to assess the condition of the scanned golf ball, and the assessed condition is presented to the user, e.g., in terms of playability of the golf ball, which may account for the user's preferences and/or game as determined from user data. And, in some aspects, this method 400 is performed in a mobile application or the like when a user scans a golf ball, e.g., without any identification, compatibility assessments, and/or golf ball recommendations. However, it shall further be understood that, in other aspects, at least some portions of the method 300 described above for FIG. 3—i.e., related to identifying the golf ball, determining its compatibility with a user, and/or making recommendations of candidate golf balls for the user—may also or instead be performed along with at least some of the portions of the method 400 of FIG. 4 related to determining a condition of the scanned golf ball and presenting salient information to a user related thereto. Thus, it will be understood that some implementations of the present teachings include a combination of at least some parts of the method 300 described above for FIG. 3 and at least some parts of the method 400 of FIG. 4. For example, a user may scan a golf ball using a mobile application or the like, and—after analysis by one or more machine learning models or the like-receive output such as one or more of: identification of the scanned ball; compatibility of the scanned ball as related to the user's game, preferences, and/or goals; condition of the scanned ball, e.g., as related to the user's game, preferences, and/or goals; and/or one or more other golf balls recommended for the user, e.g., accounting for the user's game, preferences, and/or goals.

As discussed above and elsewhere herein, the method 400 may be executed by a computer program product comprising computer executable code embodied in a non-transitory computer readable medium that, when executing on one or more computing devices, causes the one or more computing devices to perform one or more steps of the method 400. For example, a mobile application executing on a user's smartphone may perform one or more steps of the method 400, locally and/or with the support of remote processing (e.g., a remote server or the like).

As shown in step 402, the method 400 may include receiving user data, which may be the same as, similar to, or include any of the features of step 302 described above, or otherwise receiving user data, where such user data may include any described herein. Thus, the method 400 may include receiving user data from a user, the user data including information related to at least one of playing characteristics, playing preferences, and challenges during play for the user. In particular, the user data may include information that is salient to determining a user's likely preferences for playing with balls having certain conditions such as a degree of damage, soiling, age, and/or the like.

As shown in step 404, the method 400 may include storing the user data, which may be the same as, similar to, or include any of the features of step 304 described above, or otherwise storing and/or retrieving stored user data.

As shown in step 406, the method 400 may include receiving a scan of a golf ball from a user device, the scan performed using a camera of the user device, e.g., a smartphone. This step 406 may be the same as, similar to, or include any of the features of step 406 described above.

As shown in step 408, the method 400 may include analyzing the scan to identify a condition of the golf ball. This may involve the use of one or more damage analysis models trained on a plurality of images of golf balls of varying conditions, where an output of such models is an identification or other information related to a condition of the golf ball. In some aspects, one or more of the damage analysis models analyze one or more dimples included on the golf ball. This may include an assessment of the condition of one or more of the dimples on a surface of a golf ball, such as whether the dimple is soiled, intact, scuffed, scraped, defines a clear boundary, has a predetermined shape, has a predetermined depth, has a predetermined size, whether there are a predetermined number of dimples found in a predetermined region on the surface of the golf ball, and the like. Also or instead, one or more of the damage analysis models may analyze one or more color changes on the golf ball, such as whether these color changes indicate soiling, scuffing, scratching, markings placed by a user or third party (i.e., not the manufacturer of the golf ball), debris, and the like. Also or instead, one or more of the damage analysis models may analyze a geometry of at least a portion of the surface of the golf ball, such as to determine whether the golf ball matches a predetermined shape, includes dents, includes holes, includes scrapes or scratches, otherwise deviates from an intended post-manufacturing shape, and the like.

Therefore, in certain aspects, the condition of the golf ball may account for a presence of one or more of a scuff, a scratch, a hole, a defect, soiling, and the like on the surface of the golf ball. Also or instead, the condition of the golf ball may account for a defect in an overall shape of the golf ball—where such a defect will be understood to include, in some aspects, a deviation from an intended post-manufacturing shape. Thus, it will be understood that one or more models may be trained using—or may otherwise retrieve this information for a condition analysis-one or more of: a plurality of images and/or scans of golf balls, which may be of different types, and which may include different conditions for comparison for identification by a model; data retrieved from manufacturer specifications and the like (such as data that indicates coloring, markings, shape, features, dimple properties, size, tolerances, material properties, and/or the like); and the like.

As shown in step 410, the method 400 may include scoring a playability of the golf ball based on the condition, e.g., using one or more damage analysis models, which may be the same or similar to those described above. This scoring may be relatively objective, only accounting for the condition of the golf ball as determined by one or more of the models, and/or other objective data. However, and advantageously, this scoring may account for the user data in view of the determined condition. Stated otherwise, in some aspects, the user data influences an output (e.g., metric) related to the playability of the golf ball for the user. Thus, an aspect includes scoring, using one or more damage analysis models, a playability of the golf ball based on the condition and the user data. For example, and as described above, the user data may include user supplied information related to their particular condition preferences for golf balls (e.g., whether a user prefers new balls, or can play with slightly scuffed balls, and similar). Thus, a questionnaire or the like supplied to a user to obtain user data may include questions or prompts directly related to the user's preferences for condition and/or playability of golf balls. Also or instead, the user data may include indirect information related to determining a playability of a golf ball for a particular user. By way of example, if the user data indicates that a particular user is a beginner or casual golfer, this information can be used by the models to assume that the particular user may find an imperfect ball playable, and degrees related thereto may be created and used by a model; and/or if the user data indicates that a particular user is an advanced or serious golfer, this information can be used by the models to assume that the particular user may find an imperfect ball unplayable or otherwise less desirable, and degrees related thereto may be created and used by a model. Also or instead, a machine-learning model may learn, through training or updates from a plurality of uses and increased data acquisition, playability preferences for certain user groups as determined from user data-such as users of similar skill levels, users that answer certain queries or prompts in a particular way, users in a similar location, users of similar means, and so forth.

As shown in step 412, the method 400 may include presenting, on the display of the user device, a metric related to the playability of the golf ball for the user. For example, in certain aspects, the metric related to the playability of the golf ball includes at least one of: a recommendation not to play with the golf ball, an indication that the golf ball may cause impaired play, an indication that the golf ball is in a playable condition, an indication that the golf ball is in a new condition, and the like. Also or instead, the metric related to the playability of the golf ball may include one or more of the following related to playability: a grade, a score, a label, a rating, a graph, a representation, and the like, or any other information related to the condition and/or playability of the golf ball for the user. By way of example, the grade may include a percentage relating to playability or condition from 0% to 100%, and may include one or more graphical representations (e.g., shading or coloring on a scale to provide a visual representation of the playability or condition of the golf ball).

Other outputs are also or instead possible. For example, text may be provided to the user (e.g., on a user interface of a mobile application) that evaluates the condition and/or playability of a scanned ball—e.g., “ball is in a fair condition; can cost you 10% of driver distance, and move the ball off line significantly.”

A brief overview of an example of the golf ball condition analysis (e.g., damage analysis) process will now be described. The process may include an innovative approach to assess the playability of golf balls based on the analysis of damaged dimples. A model may predict the rate of playability, categorizing golf balls into different conditions such as “Do Not Play,” “Impaired Play,” “Somewhat Impaired,” “Playing Condition,” and “New Condition.” The development of this model may involve various stages, including dataset creation, the utilization of a MobileNet model, and rigorous training and evaluation processes.

Continuing with this example, an objective of the damage analysis model may include leveraging machine learning techniques to analyze damaged dimples on golf balls and to predict their playability status. The model may employ a five-tier categorization, ranging from a complete recommendation against playing to identifying golf balls in new condition. This predictive system may be used to enhance decision-making for golfers, ensuring they choose golf balls that align with their desired playing conditions.

This example may include the creation of a dataset for the damage analysis model. To train the damage analysis model effectively, a diverse and representative dataset may be used. The process may include collecting images from users who scan their golf balls, capturing the nuances of the damages. These images may be thoroughly annotated using specialized image labeling tools, providing the model with labeled data for robust training.

This example may include model training. For the training phase, the model may utilize MobileNet, a deep learning model built on TensorFlow. MobileNet's architecture may enable efficient and effective training, accommodating the characteristics of golf ball damage. The model may thus learn to recognize patterns in damaged dimples and to correlate them with the corresponding playability states.

This example may include an evaluation. The evaluation phase may ensure the model's accuracy and reliability. The dataset may be partitioned for training and testing purposes, with the model being exposed to various damaged dimple scenarios. Standard metrics such as precision, recall, and FI score may be employed to assess the model's performance. This rigorous evaluation can help refine the model for optimal results in real-world applications.

Thus, the above-described golf ball damage analysis model may represent a significant advancement in golf ball assessment technology. By incorporating machine learning and image analysis, it can offer golfers a nuanced understanding of their golf balls' conditions, aiding in decision-making for an optimal playing experience.

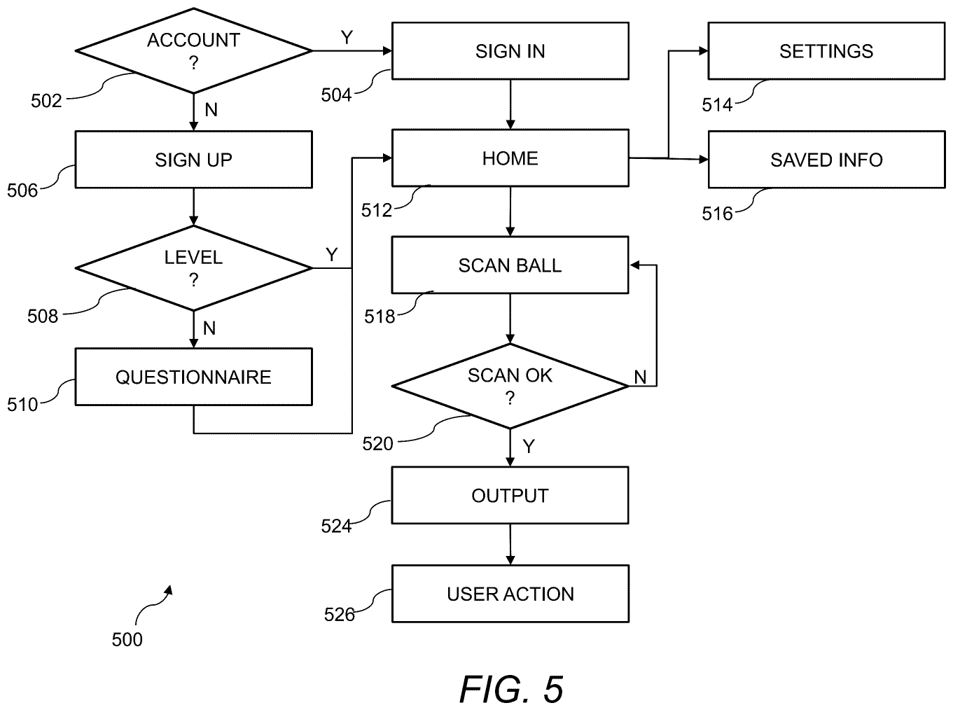

FIG. 5 is a flow diagram showing use of a platform for scanning an object such as a golf ball, in accordance with a representative embodiment. Specifically, FIG. 5 shows an example method 500 demonstrating use and functionality of an application (e.g., a smartphone application, mobile application, or the like) implementing an example of the present teachings.

As shown in step 502, the method 500 may include establishing whether a particular user has an account for a platform implementing the present teachings. If so, a user may be prompted to sign into the platform as shown in step 504; if not, a user may be prompted to sign up or otherwise register for the platform as shown in step 506. However, some aspects of the platform may not require a user to be registered and/or signed into the platform in order to proceed to further steps of the method 500.

As shown in step 508, the method 500 may include establishing whether the platform has access to certain information (e.g., skill level) about the user, such as any of the user data described herein. If so, a user may proceed to a home page or the like as shown in step 512; if not, a user may be prompted to input information such as via a questionnaire or the like as shown in step 510. The questionnaire may be the same or similar to any as described herein, and in general may be used to acquire user data from the user. For example, acquiring user data may include prompting the user to answer questions such as: “How long is your typical drive off the tee?; “The most common ball flight for your drive is?”; “The most common trajectory for your drive is?”; “My biggest challenge with drives is?”; “My biggest challenge with hitting a pitching wedge onto a green is?”; “When buying a golf ball, I look for the following”; “List three balls that you commonly use in playing a round of golf?”; and/or the like. Some or all of these questions may include preset answers for the user to select. For example, when prompted to list golf balls that a user plays with, the platform may provide a plurality of brands and/or models of balls for a user to choose (e.g., via a drop down menu or similar). One or more of these prompts/questions may be skipped by a user, where in some cases, a default value is provided for the user on the backend of the platform for such non-answers. When a user has completed the input of user data via a questionnaire or the like, the user may be sent to a home page as shown in step 512.

A home page for a platform implementing the present teachings may include access to settings as shown in box 514 and/or access to saved information (e.g., user data) as shown in box 516. Saved information may include any as described herein, and by way of example may also or instead include saved results from previous scans or recommendations, favorited balls or otherwise balls that have been recommended, selected, scanned, rated, or similar, and so on. A home page may also or instead provide access to functionality related to scanning a ball.

As shown in step 518, the method 500 may include scanning a golf ball. If the scan is determined to be acceptable for processing (e.g., by one or more of the machine learning models and/or algorithms described herein), the scan may be processed and the method 500 may continue to step 524; if the scan is determined to be unacceptable for processing, the method 500 may prompt the user to re-scan the ball, all as shown by box 520.

As shown in step 524, the method 500 may include providing output to the user based at least in part on the scan of the ball, where the output may include any as described herein. By way of example, the output may include one or more of the following: a scale (e.g., graphical scale or meter), a score, or the like showing whether the scanned ball is a poor fit or the best fit, or anything in-between; brand and/or model of the scanned ball; production year of the scanned ball; distance rating or other distance information or metrics related to the scanned ball; spin rating or other spin information or metrics related to the scanned ball; control rating or other control information or metrics related to the scanned ball; how a metric of the scanned ball relates to the user's game based on the user data; alternate balls (e.g., recommended balls for the user); and the like.

As shown in step 526, the method 500 may include providing one or more prompts for user action, e.g., related to one or more of the scanned ball or recommended balls. For example, this may include a prompt for the user to add a ball to their favorites (or to otherwise save data related to a ball). Such a prompt may also or instead include a link or the like to purchase a particular ball—e.g., a link to a third-party website, an external review of the golf ball, and so forth.

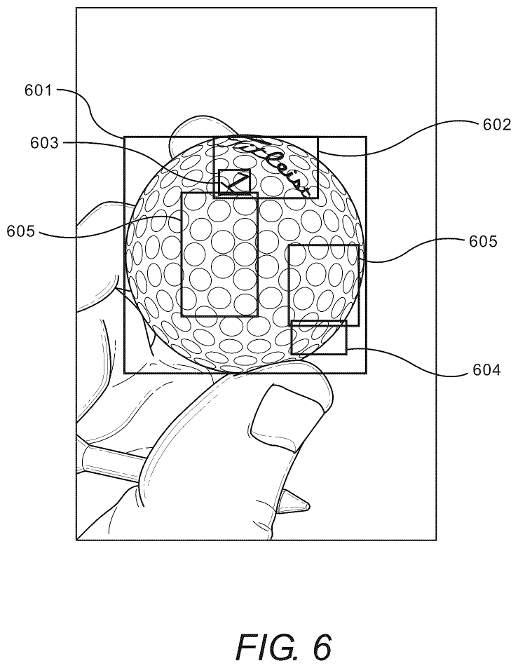

FIG. 6 shows an example of object recognition, in accordance with a representative embodiment. In particular, this figure shows bounding boxes representing certain inputs for processing from the scan, which can be retrieved using one or more of the object recognition and/or scanning techniques described herein, such as: a first box 601 including an overall boundary for the scanned ball, where information processed therefrom can include a color, a shape, a processing region, and so on; a second box 602 including a manufacturer or brand logo and/or text/characters/symbols related thereto; a third box 603 including a model logo or and/or text/characters/symbols related thereto; a fourth box 604 including other markings on the ball (e.g., user or manufacturer created markings, such as alignment aids or the like); and one or more fifth boxes 605 including areas containing visible condition-related issues such as damage and/or soiling.

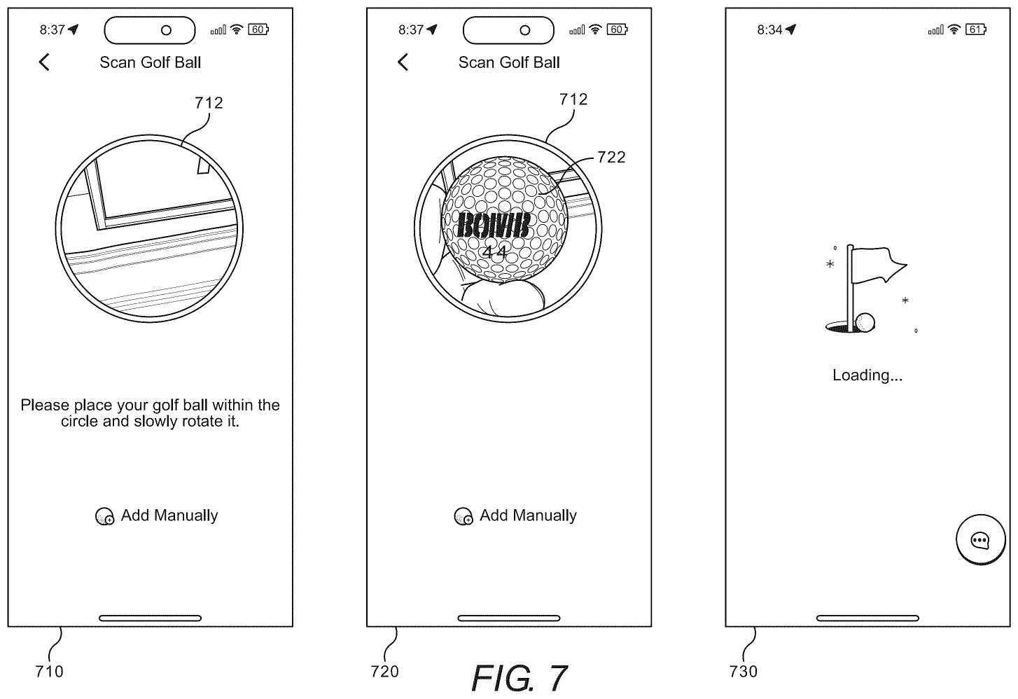

FIG. 7 shows screenshots of a platform for scanning an object such as a golf ball, in accordance with a representative embodiment. Specifically, this figure shows a first screen 710 that cooperates with a camera on a user device to prompt a user to scan a ball. Specifically, the first screen 710 may include a window 712 for a user to place a golf ball (e.g., hold and/or rotate the golf ball in view of the camera so it appears within the window 712) for scanning the golf ball. The first screen 710 may include text or the like for instructing the user, such as the example text shown in the figure, which states, “Please place your golf ball within the circle and slowly rotate it.” The first screen 710 may also or instead include a prompt for a user to manually add a golf ball for processing, e.g., for processing compatibility in view of user data. FIG. 7 further shows a second screen 720 with a golf ball 722 within the window 712 for scanning, and a third screen 730 which may be displayed during backend processing of the golf ball and/or scan.

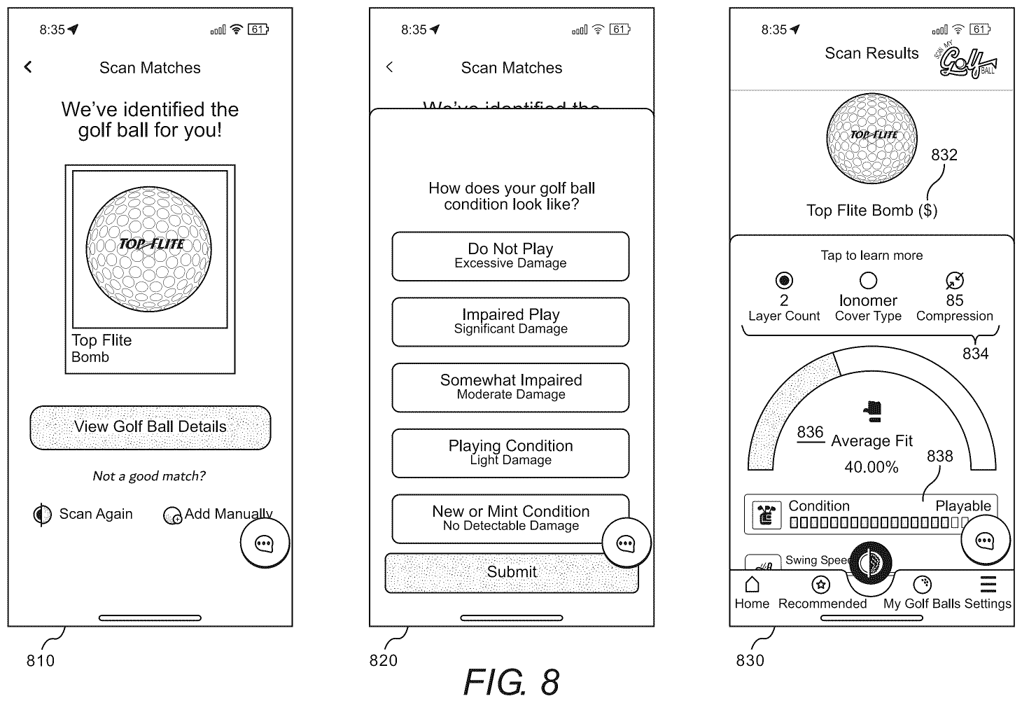

FIG. 8 shows screenshots of a platform for scanning an object such as a golf ball, in accordance with a representative embodiment. Specifically, this figure shows a first screen 810 that may be displayed once a scan of a golf ball has been processed. As shown in this figure, the first screen 810 may include certain output such as: an image of the scanned golf ball (which may be an actual image of the particular golf ball that was scanned, a stock image of a representative golf ball having the same or similar brand and/or model as the scanned golf ball, or a customized image of a representative golf ball—e.g., where an image of a golf ball is manipulated to match one or more features (such as color) of the scanned golf ball). The image may include one or more labels such as the brand name/manufacturer and/or model of the scanned golf ball. The first screen 810 may also or instead include one or more prompts for user interaction such as any of the following: a prompt to view more details related to the identified golf ball from the scan (such as play-based attributes of the identified golf ball), a prompt to redo the scan and/or manually add the golf ball if the output from the scan is not a good match; a prompt to scan again; a prompt to add manually; and the like.

The second screen 820 shows an example of user prompts that may be provided for user selection, for example, where answers to these prompts can be used for training machine learning models that process scans of golf balls. By way of example, the second screen 820 shows prompts related to a condition of the scanned ball; for example, as shown in the figure, the prompts may include a query such as “How does your golf ball condition look like?” where predetermined answers can include: “Do Not Play, Excessive Damage”; “Impaired Play, Significant Damage”; “Somewhat Impaired, Moderate Damage”; “Playing Condition, Light Damage”; “New or Mint Condition, No Detectable Damage”; and the like.

The third screen 830 shows various output related to the golf ball identified from the scan, and may be a screen that is displayed after a user selects “View Golf Ball Details” in the first screen 810. By way of example, the third screen 830 can show a cost attribute 832 related to the identified golf ball—e.g., a representation such as one dollar sign indicating a lower priced ball, two dollar signs indicating a moderate priced ball, three dollar signs indicating a higher priced ball, and so on. Other values, metrics, and representations of a cost attribute are also or instead possible. The third screen 830 may also or instead show one or more play-based attributes 834 of the identified golf ball, such as its layer count, cover type, and compression. The third screen 830 may also or instead show a compatibility metric 836 of the identified golf ball as determined by one or more matching algorithms or the like, e.g., where this information can be based at least in part on user data as described herein. The compatibility metric 836 may include one or more graphical representations (e.g., such as the scale and thumbs-up symbol shown in the figure) and/or scores, grades, ratios, graphs, and so forth. The third screen 830 may also or instead show a playability metric 838 related to a condition of the identified golf ball as determined by one or more damage analysis models, e.g., where this information can be based at least in part on user data as described herein. The playability metric 838 may include one or more graphical representations and/or scores, grades, ratios, graphs, and so forth.

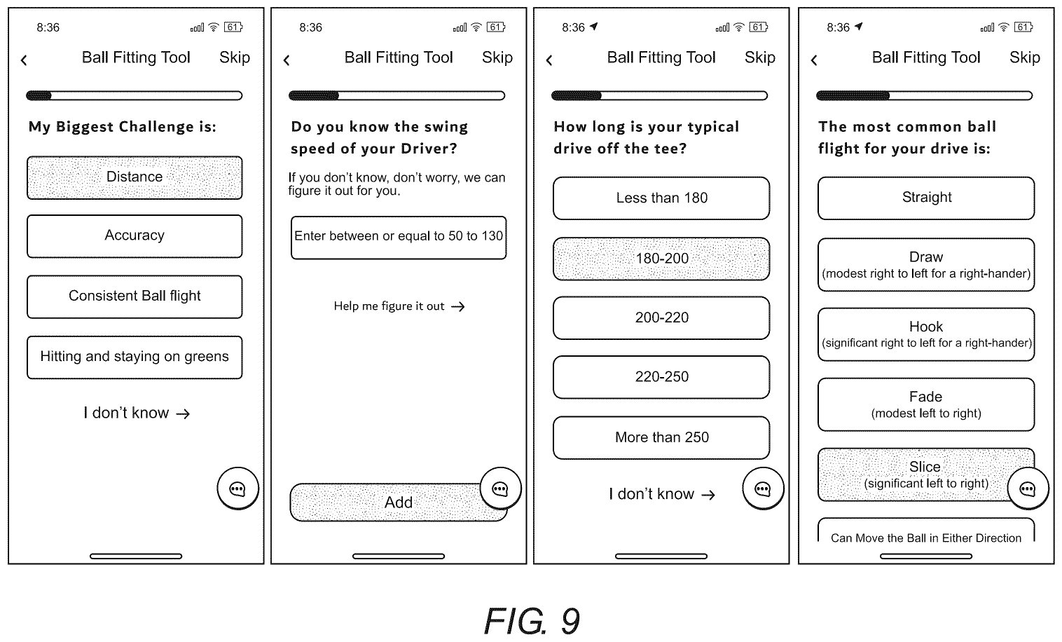

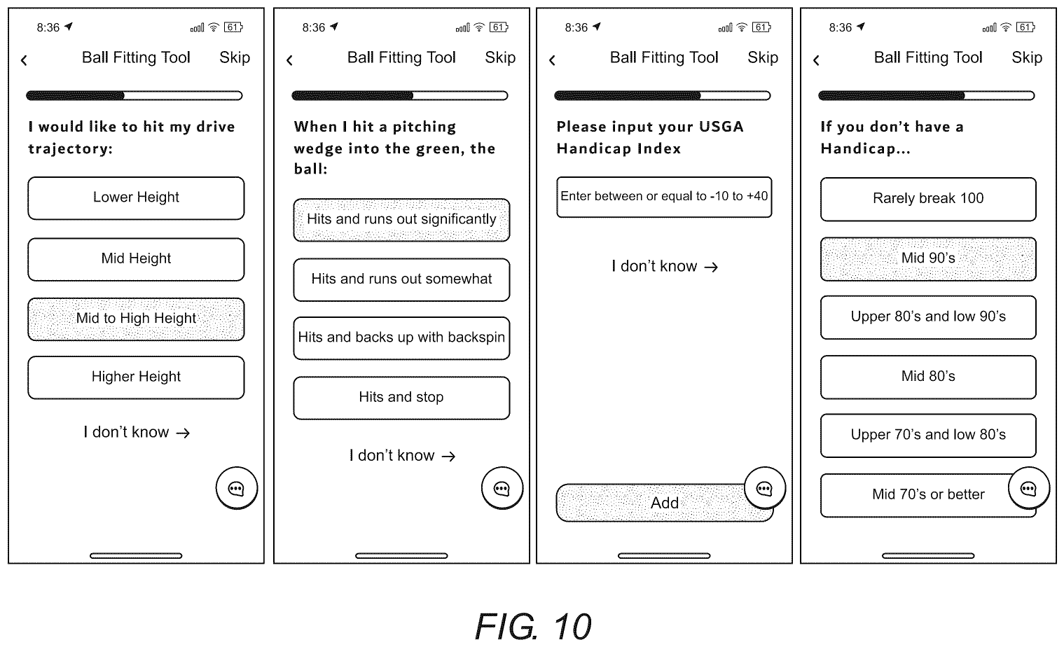

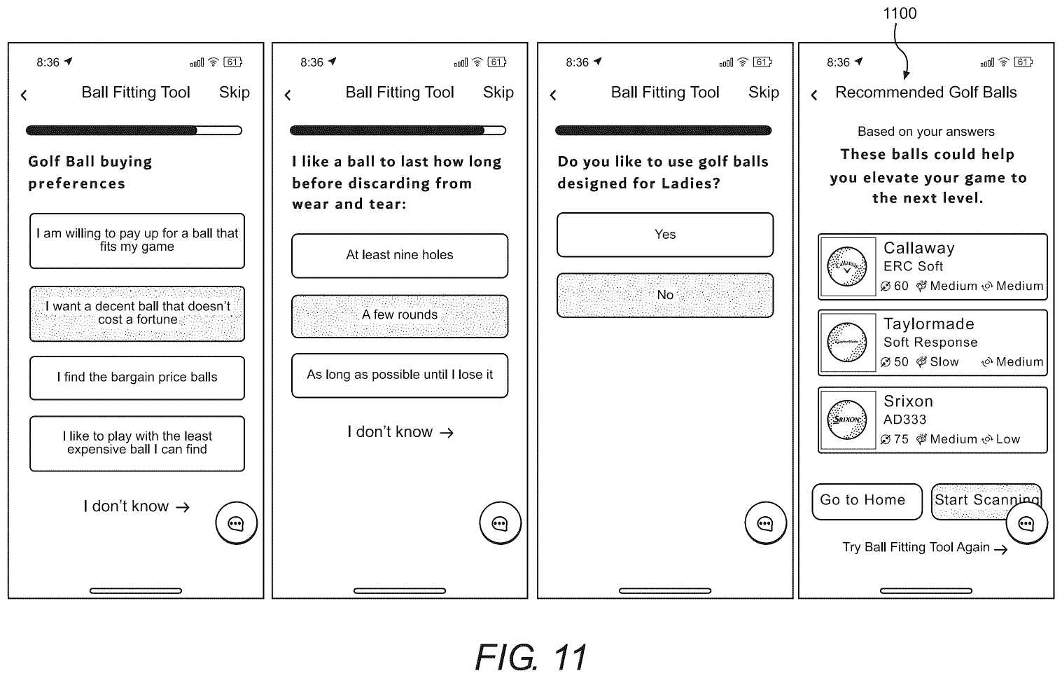

FIGS. 9-11 show screenshots of a platform for scanning an object such as a golf ball, in accordance with a representative embodiment. For example, the screens shown in FIGS. 9 and 10 show examples of how the platform may gather user data via a questionnaire or other user prompts. As shown in FIG. 11, output 1100 from evaluating the user data (e.g., as provided in the prompts and example questions shown in FIGS. 9-11 by way of example) may include one or more recommendations for golf balls for the user.

The above systems, devices, methods, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogencous combinations of processors, processor architectures, or combinations of different hardware and software. In another aspect, the methods may be embodied in systems that perform the steps thereof, and may be distributed across devices in a number of ways. At the same time, processing may be distributed across devices such as the various systems described above, or all of the functionalities may be integrated into a dedicated, standalone device or other hardware. In another aspect, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random-access memory associated with a processor), or a storage device such as a disk drive, flash memory or any other optical, electromagnetic, magnetic, infrared, or other device or combination of devices. In another aspect, any of the systems and methods described above may be embodied in any suitable transmission or propagation medium carrying computer-executable code and/or any inputs or outputs from same.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings.

Unless the context clearly requires otherwise, throughout the description, the words “comprise,” “comprising,” “include,” “including,” and the like are to be construed in an inclusive sense as opposed to an exclusive or exhaustive sense; that is to say, in a sense of “including, but not limited to.” Additionally, the words “herein,” “hereunder,” “above,” “below,” and words of similar import refer to this application as a whole and not to any particular portions of this application.

It will be appreciated that the devices, systems, and methods described above are set forth by way of example and not of limitation. For example, regarding the methods provided above, absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the implementations described herein are intended to include any suitable method of causing such method steps to be performed, consistent with the patentability of the following claims, unless a different meaning is expressly provided or otherwise clear from the context. So, for example performing the step of X includes any suitable method for causing another party such as a remote user, a remote processing resource (e.g., a server or cloud computer) or a machine to perform the step of X. Similarly, performing steps X, Y, and Z may include any method of directing or controlling any combination of such other individuals or resources to perform steps X, Y, and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

While particular embodiments have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

What is claimed is:

1. A computer program product comprising computer executable code embodied in a non-transitory computer readable medium that, when executing on one or more computing devices, causes the one or more computing devices to perform the steps of:
receiving a scan of a golf ball from a user device, the scan performed using a camera of the user device;
analyzing the scan using one or more identification algorithms to identify the golf ball, the one or more identification algorithms performing at least one of character recognition and logo recognition to determine at least one of a brand and a model of the golf ball;
querying a golf ball database for one or more play-based attributes of the identified golf ball, the golf ball database including a plurality of play-based attributes for each of a plurality of golf balls;
receiving user data from a user, the user data including information related to at least one of playing characteristics, playing preferences, and challenges during play for the user;
comparing, using one or more matching algorithms, the user data to the one or more play-based attributes of the identified golf ball;
scoring, using the one or more matching algorithms, a compatibility of the identified golf ball for the user based on the comparison of the user data to the one or more play-based attributes;
presenting, on a display of the user device, a score for the compatibility of the identified golf ball for the user;
analyzing the scan, using one or more damage analysis models trained on a plurality of images of golf balls of varying conditions, to identify a condition of the golf ball;
scoring, using the one or more damage analysis models, a playability of the golf ball based on the condition and the user data; and
presenting, on the display of the user device, a metric related to the playability of the golf ball for the user.

2. The computer program product of claim 1, further comprising code that, when executing on one or more computing devices, causes the one or more computing devices to perform the steps of:
comparing, using the one or more matching algorithms, the user data to the plurality of play-based attributes of golf balls in the golf ball database that are different from the identified golf ball;
selecting, using the one or more matching algorithms, one or more candidate golf balls for the user based on the comparison of the user data to the plurality of play-based attributes; and
presenting at least one of the one or more candidate golf balls to the user.

3. The computer program product of claim 2, wherein the one or more matching algorithms weight one or more of the plurality of play-based attributes based on the user data when selecting the one or more candidate golf balls for the user.

4. The computer program product of claim 2, further comprising code that, when executing on one or more computing devices, causes the one or more computing devices to perform the steps of:
scoring the one or more candidate golf balls for the user based on the comparison of the user data to the plurality of play-based attributes; and
ranking the one or more candidate golf balls based on the scoring.

5. The computer program product of claim 1, wherein the one or more matching algorithms weight one or more of the play-based attributes of the identified golf ball based on the user data when scoring the compatibility of the identified golf ball.

6. The computer program product of claim 1, wherein an identification algorithm of the one or more identification algorithms is programmatically configured to extract at least one of text and a logo from the golf ball, and to perform fuzzy matching based on the extracted text and/or the extracted logo and a database of text included on certain golf balls.

7. The computer program product of claim 1, wherein an identification algorithm of the one or more identification algorithms is programmatically configured to extract one or more features included on a surface of the golf ball, and to perform fuzzy matching based on the one or more features and a database of features included on certain golf balls.

8. The computer program product of claim 7, wherein the one or more features on the surface of the golf ball include at least one of: an attribute related to one or more dimples included on the surface of the golf ball; a color of the golf ball; and markings on the golf ball.

9. The computer program product of claim 1, wherein an identification algorithm of the one or more identification algorithms is trained using a dataset of a plurality of images of golf balls, the dataset including one or more tags for each of the plurality of images, the one or more tags including at least one of a brand, a model, and a logo.

10. The computer program product of claim 1, wherein the one or more damage analysis models analyze at least one of: one or more dimples included on the golf ball; one or more color changes on the golf ball; and a geometry of at least a portion of a surface of the golf ball.

11. The computer program product of claim 1, wherein the condition of the golf ball accounts for a presence of one or more of a scuff, a scratch, soiling on a surface of the golf ball, and a defect in an overall shape of the golf ball.

12. The computer program product of claim 1, wherein the metric related to the playability of the golf ball includes at least one of: a recommendation not to play with the golf ball; an indication that the golf ball may cause impaired play; an indication that the golf ball is in a playable condition; an indication that the golf ball is in a new condition; and a grade related to playability.

13. The computer program product of claim 1, wherein the user data includes one or more of the following: gender, age, drive distance, ball flight, desired ball trajectory, challenges faced, greenside spin, handicap, score range, value preference, and an expected durability of golf balls.

14. The computer program product of claim 1, wherein the user data is weighted, and wherein weighting of the user data is based at least in part on an identification of importance of certain information provided by the user.

15. The computer program product of claim 1, wherein the user data influences the metric related to the playability of the golf ball for the user.

16. The computer program product of claim 1, wherein the user data includes data from a population of users, and wherein the data from the population of users is used, at least in part, to score the compatibility of the golf ball, to make a recommendation of candidate golf balls, or to score the playability of the golf ball.

17. The computer program product of claim 1, wherein the user device includes a smartphone.

18. The computer program product of claim 1, further comprising code that, when executing on one or more computing devices, causes the one or more computing devices to perform the step of identifying one or more third-party logos on the golf ball based on the scan.

19. A system, comprising:
a user device including a camera and a display;
one or more models stored in a memory, the one or more models configured to analyze a scan of a golf ball performed using the camera of the user device; and
a processor configured by computer executable code to perform the steps of:
analyzing the scan using the one or more models to identify the golf ball, the one or more models performing at least one of character recognition and logo recognition to determine at least one of a brand and a model of the golf ball;
querying a golf ball database for one or more play-based attributes of the identified golf ball, the golf ball database including a plurality of play-based attributes for each of a plurality of golf balls;
receiving user data from a user, the user data including information related to at least one of playing characteristics, playing preferences, and challenges during play for the user;
comparing, using the one or more models, the user data to the one or more play-based attributes of the identified golf ball;
scoring, using the one or more models, a compatibility of the identified golf ball for the user based on the comparison of the user data to the one or more play-based attributes;
presenting, on the display of the user device, a score for the compatibility of the identified golf ball for the user;
analyzing the scan, using a model of the one or more models trained on a plurality of images of golf balls of varying conditions, to identify a condition of the golf ball;
scoring, using the one or more models, a playability of the golf ball based on the condition and the user data; and
presenting, on the display of the user device, a metric related to the playability of the golf ball for the user.

20. A method, comprising:
receiving a scan of a golf ball from a user device, the scan performed using a camera of the user device;
analyzing the scan using one or more identification algorithms to identify the golf ball, the one or more identification algorithms performing at least one of character recognition and logo recognition to determine at least one of a brand and a model of the golf ball;
querying a golf ball database for one or more play-based attributes of the identified golf ball, the golf ball database including a plurality of play-based attributes for each of a plurality of golf balls;
receiving user data from a user, the user data including information related to at least one of playing characteristics, playing preferences, and challenges during play for the user;
comparing, using one or more matching algorithms, the user data to the one or more play-based attributes of the identified golf ball;
scoring, using the one or more matching algorithms, a compatibility of the identified golf ball for the user based on the comparison of the user data to the one or more play-based attributes;
presenting, on a display of the user device, a score for the compatibility of the identified golf ball for the user;
analyzing the scan, using one or more damage analysis models trained on a plurality of images of golf balls of varying conditions, to identify a condition of the golf ball;
scoring, using the one or more damage analysis models, a playability of the golf ball based on the condition and the user data; and
presenting, on the display of the user device, a metric related to the playability of the golf ball for the user.
